(19) United States
(12) Patent Application Publication
(10) Pub. No.: US 2003/0236714 A1
(43) Pub. Date: Dec. 25, 2003

(54) Profile information transmitting apparatus

(76) Inventor: Mitsuhiro Kageyama, Tokyo (JP)

Correspondence Address: Gerald Levy, Esq., PITNEY, HARDIN, KIPP & SZUCH LLP, 685 Third Avenue, New York, NY, 10017-4024, US

(21) Appl. No.: 10/440,913

(22) Filed: May 19, 2003

(30) Foreign Application Priority Data
Jun. 19, 2002 (JP) JP 2002-178997

(51) Int. Cl. G06F 17/60

(52) U.S. Cl. 705/26

(57) ABSTRACT

Conventionally, when users desire to purchase the content, such as music and images, etc., distributed through the Internet, it is necessary to re-access and carry out downloading of regular data after first downloading, viewing and listening to the sample data. However, in order to purchase content, it was bothersome for users to download twice with sample data and the regular data for purchase as mentioned above, thereby decreasing users' desire to purchase the content. In the present invention, in order to solve the above, the whole content is downloaded from the beginning. A user can play back the data based on the profile specifying the area in which the data can be played back. Thereby it becomes possible to control the playback from the distributor side, even if all the content is distributed to a user.

### BACKGROUND OF THE INVENTION

1. Field of the Invention

The present invention relates to profile information transmitting apparatus.

2. Description of the Related Art

Conventionally, when users desire to purchase content, such as music and images, etc., distributed through the Internet, it is necessary to access again and download regular data after downloading, viewing, and listening to the sample data first.

However, in order to purchase content, it is bothersome for users to download twice with sample data and the regular data for purchase as mentioned above, thereby reducing users' desire for purchase of the content.

In addition, the downloaded content is always the only one that can be played back.

### SUMMARY OF THE INVENTION

In the present invention, in order to solve the above deficiency, the entire content is downloaded from the beginning. An user acquires the profile information which makes it possible to play back the data separately, and plays back the content based on that profile information. Thereby it becomes possible to control playback from the distributor's side, even if all the content is distributed to a user.

In addition, it becomes possible to extract music or images from the content which comprises music and images, and to play back them.

### BRIEF DESCRIPTION OF THE DRAWINGS

FIG. 1 is a schematic diagram to illustrate the first embodiment,

FIG. 2 is a block diagram of the first embodiment,

FIG. 3 is a diagram illustrating an example of the content discernment information and an example of the profile information

FIG. 4 is a diagram illustrating an example of the profile information generated in case of purchasing a part of the content

FIG. 5 is a flow chart demonstrating the details of the process of the first embodiment,

FIG. 6 is a block diagram of the second embodiment,

FIG. 7 is a flow chart demonstrating the process of the second embodiment,

FIG. 8 is a block diagram of the third embodiment,

FIG. 9 is a flow chart demonstrating the first process of the third embodiment,

FIG. 10 is a flow chart demonstrating the second process of the third embodiment,

FIG. 11 is a block diagram of the sixth embodiment,

FIG. 12 is a flow chart demonstrating the process of the sixth embodiment,

FIG. 13 is a block diagram of the seventh embodiment,

FIG. 14 is a flow chart demonstrating the process of the seventh embodiment,

FIG. 15 is a diagram illustrating the fee collection process in the eighth embodiment,

FIG. 16 is a block diagram of the tenth embodiment,

FIG. 17 is a flow chart demonstrating the process of the tenth embodiment,

FIG. 18 is a diagram illustrating the first process of the acquisition of the key described in the eleventh embodiment,

FIG. 19 is a diagram illustrating the second process of the acquisition of the key described in the eleventh embodiment,

FIG. 20 is a block diagram of the twelfth embodiment,

FIG. 21 is a flow chart demonstrating the process of the twelfth embodiment,

FIG. 22 is a schematic diagram illustrating the process of the reconstruction of the coded streaming file data described in the fourteenth embodiment.

FIG. 23 is a block diagram of the fifteenth embodiment,

FIG. 24 is a flow chart demonstrating the process of the fifteenth embodiment,

FIG. 25 is a diagram illustrating the classification of the layer information, described in the sixteenth embodiment, classified by resolution.

FIG. 26 is a diagram illustrating the structure of scalability described in the sixteenth embodiment.

FIG. 27 is a block diagram of the eighteenth embodiment,

FIG. 28 is a block diagram of the nineteenth embodiment,

FIG. 29 is a block diagram of the twenty-fourth embodiment,

FIG. 30 is a flow chart demonstrating the process of the twenty-fourth embodiment,

FIG. 31 is a block diagram of the twenty-fifth embodiment,

FIG. 32 is a diagram illustrating the process of taking synchronization using the time stamp described in the twenty-fifth embodiment.

FIG. 33 is a diagram illustrating the process of establishing synchronization using the ID described in the twenty-sixth embodiment.

FIG. 34 is a schematic diagram illustrating the twenty-eighth embodiment,

FIG. 35 is a block diagram of the twenty-eighth embodiment,

FIG. 36 is a flow chart demonstrating the process of the twenty-eighth embodiment,

FIG. 37 is a block diagram of the twenty-ninth embodiment,

FIG. 38 is a block diagram of the thirtieth embodiment,

FIG. 39 is a flow chart demonstrating the process of the first embodiment,

FIG. 40 is a flow chart demonstrating the playback process of the content described in the fifth embodiment.

### DESCRIPTION OF THE PREFERRED EMBODIMENTS

The embodiments of the present invention will be described hereinafter. Furthermore, there is no limitation on the present invention in these embodiments, and the present invention may be practiced in various modes without departing from the scope of it.

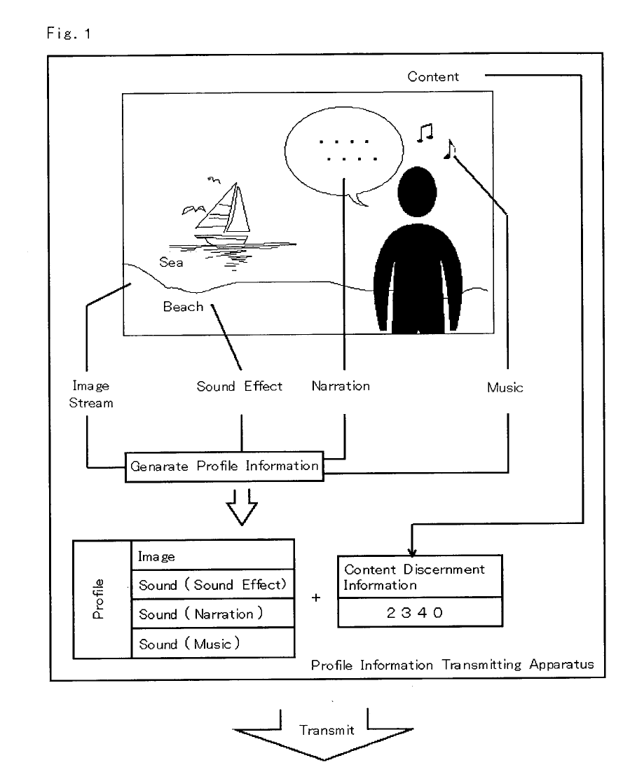

The first embodiment will be described. The present embodiment is the profile information transmitting apparatus which transmits the profile information. FIG. 1 shows an example of the concept of the present embodiment. As shown in FIG. 1, the content comprises an image in which a person makes a report, a narration by the person who makes the report, music of BGM, and the sound of the ocean. These four elements are stored each as streaming files. Here the profile information, which is necessary information to play back according to the combination of multiple streaming files, is acquired. With this profile information, it becomes possible for users to play back the streaming files of the content transmitted. In the example shown in FIG. 1, the profile information includes all four streaming files, thereby it becomes possible to play them back in the compounded state. However, the profile information may not be only all the information of streaming files which comprise the content, but also the part of the information of streaming files. For example, if the profile information specifies that only the music streaming file is played back, only the music streaming file will be played back.

In this case, it becomes possible to select the component which plays back the content according to the type of streaming file which is included in the profile information. Hence, when not only the sound streaming files but the image streaming files are comprised, the system which has image an output apparatus (screen etc.) and a sound output apparatus (speaker etc.) is necessary.

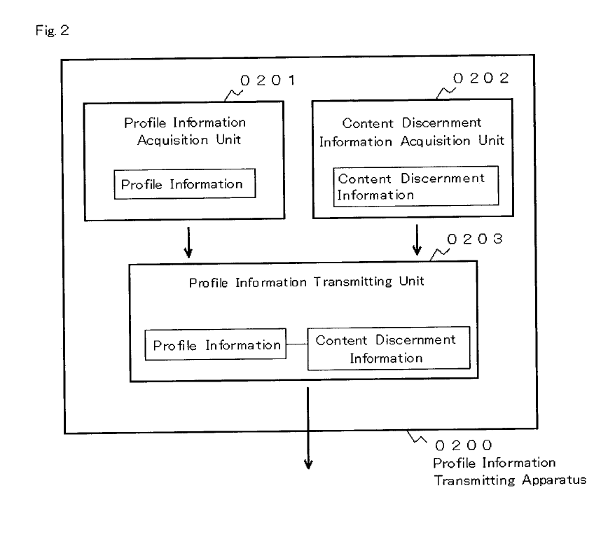

The first embodiment will be described. The present embodiment is the profile information transmitting apparatus. FIG. 2 shows an example of the block diagram in the present embodiment.

The profile information transmitting apparatus (0200), shown in FIG. 2, comprises the profile information acquisition unit (0201), the file (0202), and the profile information transmitting unit (0203).

Each part of the present invention is comprised of hardware, or software, or both. For example, when using a computer, the hardware typical includes a CPU, memory, a bus, an interface, a peripheral device, etc., and software which can be executed on the hardware.

In detail, the developed program on memory is performed one by one, thereby the function of each part is realized by processing, storing, the output, etc. of the data in memory, and the data input through an interface. (The above-mentioned is the same through the present specification)

The profile information acquisition unit (0201) acquires the profile information.

The term “profile information” corresponds to the information which includes the information for playback according to the combination of the streaming files that enable to play back the contents.

The term “content” corresponds to the information comprised of images and sounds. The content is comprised of the combination of one or more streaming files. Therefore, the streaming file corresponds to, for example, a music file, image file, etc. There is also a case that all streaming files comprising the content may be called the whole content on one hand, some part of streaming files may be called some part of the content. (That above-mentioned is the same throughout the present specification)

The term “profile information”, for example, corresponds to the type of one or more streaming files (images and music, music only, etc.), the necessary information (information on a means for synchronizing, etc.) to compose the content composed of multiple streaming files, a decoding key when a streaming file is encrypted, the information on the assignment of the area which can be played back (for example, it can be played back for 5 minutes from the start or only chapter 3, etc.).

The term “acquisition” may correspond not only to the case in which the profile information is acquired from the outside of the profile information transmitting apparatus (for example, the file transmitting apparatus etc.), but also to the case in which it is internally generated.

The content discernment information acquisition unit (0202) acquires the content discernment information.

The term “content discernment information” corresponds to the information to discern the content which can be composed of the combination of multiple streaming files. The content discernment information correlates the content with the profile information. Since the profile information is the necessary information for making it possible to play back the content according to the combination of streaming files, the content and the combination of each streaming file are correlated.

The profile information transmitting unit (0203) correlates the profile information acquired in said profile information acquisition unit with the content discernment information acquired in said content discernment information acquisition unit, and transmits them.

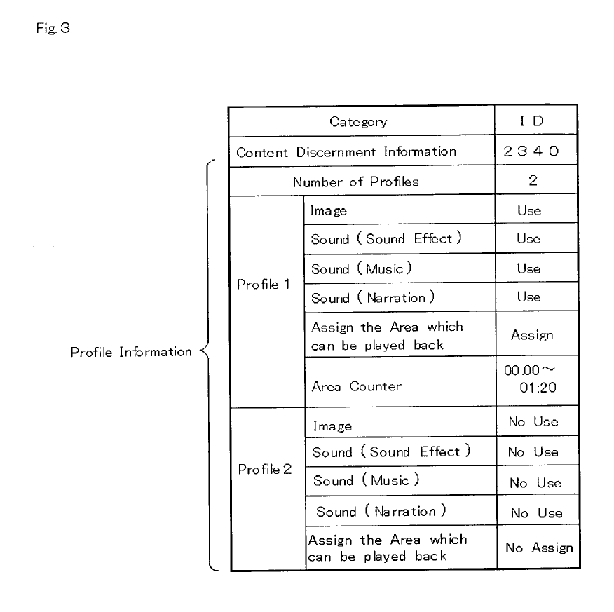

FIG. 3 shows an example of the profile information. Here, the content discerned by the content discernment information ‘2340’ has the information which contains profile 1 and profile 2. The Profile 1 is comprised of the combination of four streaming files such as images, sound effects, music, and narration, and the profile 2 is comprised of only music streaming file.

Then, the profile information necessary to play back the streaming file which comprises the same content is correlated with the content discernment information of the same content. It becomes possible to discern the profile information about the content. By such correlation, it becomes easy for users to confirm the content which users want and the profile information which corresponds to the content.

Moreover, FIG. 3 also shows the information that specifies the area which can be played back. The profile 1 is the information that makes it possible to play back all the streaming files for only 20 seconds per minute and profile 2 is the information that makes it possible to play back only the music streaming file. Therefore, even if all the streaming files which comprise the content are downloaded, it is possible to restrict playback to a part of the content according to said profile information in the content playback apparatus that the user has. In detail, the whole of the content is viewed and listened to for only 20 seconds per minute, and if the user desires to purchase the music streaming file, the profile 2 can be purchased.

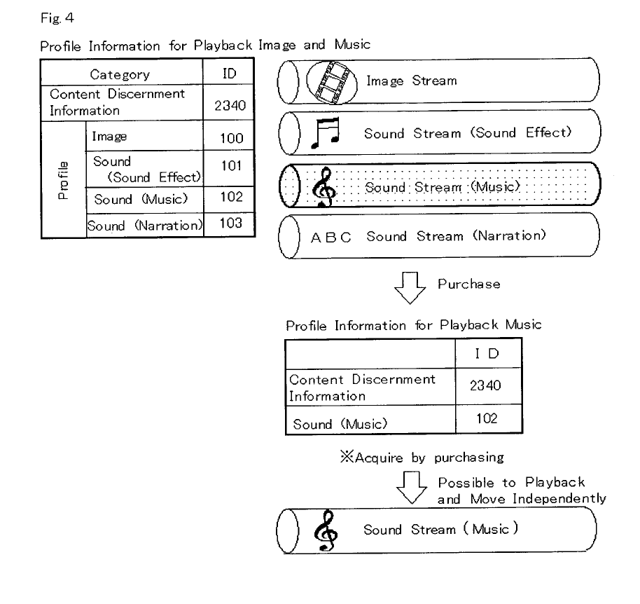

FIG. 4 shows an example of the profile information which is generated in the case that the file is purchased partially. The user can arbitrarily choose the streaming files that he wants from some streaming files and can purchase the profile information. As shown in FIG. 4, when the user purchases the music streaming file, the profile information for playback of music will be acquired. The profile for playback of music is correlated with the discernment information of content besides the discernment information of the music streaming file. Hence, it is possible to discern the information about the streaming file and it's content. It becomes possible to play back the music streaming file by acquiring the profile information for playback of the music file. Therefore, it becomes possible to move and play back the music streaming file with the profile information using a movable type media. Moreover, the streaming file that can be played back once, may be carried out playing back without profile information. Also in this case, the music streaming file can be moved and played back independently using movable type media.

In addition, all the streaming files such as images and sounds shown in FIG. 4 are stored in a user terminal in advance, and the profile information only for promotion is transmitted to it. The term profile information only for promotion corresponds to the information which becomes possible to play back only a part of the streaming files. Hence, users can acquire the profile information which makes it possible to play back all the streaming files (all the images and all the sounds) stored in users' terminals when the streaming file is wanted, viewing or listening to the promotion of that streaming file. At this time, the profile information may be acquired with the proviso of the fee collection process.

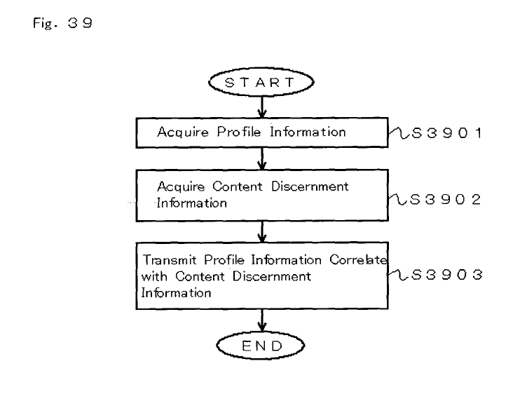

FIG. 39 demonstrates the process of the first embodiment. The transmitting process of the profile information in the present embodiment comprises the following steps:

In step S3901, the profile information, including necessary information to make it possible to play back the content which can be comprised of multiple streaming files according to the combination of streaming files, is acquired (the profile information acquisition step).

In step S3902, the content discernment information to discern said content is acquired (the content discernment information acquisition step).

In step S3903, the profile information acquired in said profile information acquisition step is correlated with the content discernment information acquired in said content discernment acquisition step, and is transmitted. (the profile information transmitting step)

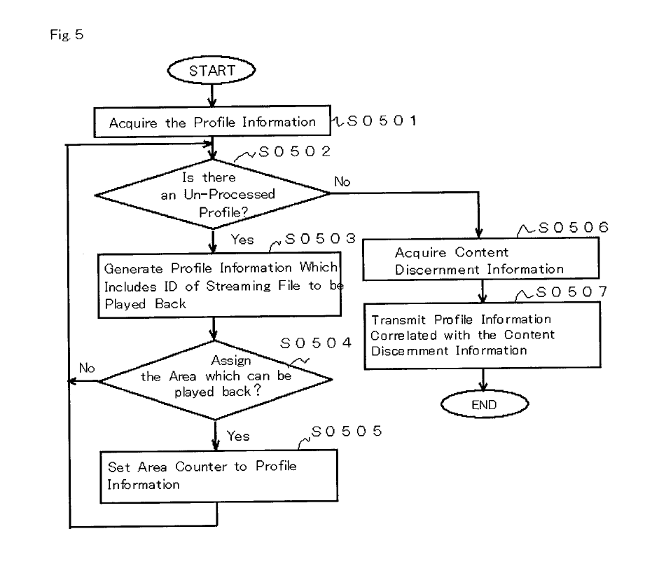

FIG. 5 demonstrates details of said process.

To start with, the profile which is data to generate profile information is acquired (the step S0501). A profile corresponds to data such as a type or a combination of streaming files. A profile becomes profile information by a process which adds Discernment ID etc. As long as this un-processed profile exists, the process from step S0502 to step S0505 will be repeated.

Firstly, it is confirmed whether the un-processed file still exists (step S0502), and if it doesn't exist, step S0506 will be processed.

As long as the un-processed file exists, the profile information which contains the ID of the streaming file (for example, image stream file, sound streaming file etc.) to be played back will be generated (step S0503).

Secondly, it is determined whether the area which can be played back is specified, and if it is not specified, step S0502 will be processed again. If the area which can be played back is specified, an area counter will be assigned to profile information (step S0505). After that, step S0502 is processed again.

In step S0502, if the un-processed profile doesn't exist, the content discernment information will be acquired (step S0506).

Finally, the profile information correlated to the content discernment information is transmitted (step S0507).

The process can be performed on the program for processing in a calculator. Moreover, it can be recorded on readable recording medium. (This applies throughout the present specification)

By transmitting the profile information using the profile information transmitting apparatus described in the first embodiment, it becomes possible to play back the part of content which has already been stored according to the preferences of a user, and to the playback terminal which he owns.

The second embodiment will be described. The present embodiment is the content transmitting apparatus which transmits the coded streaming file.

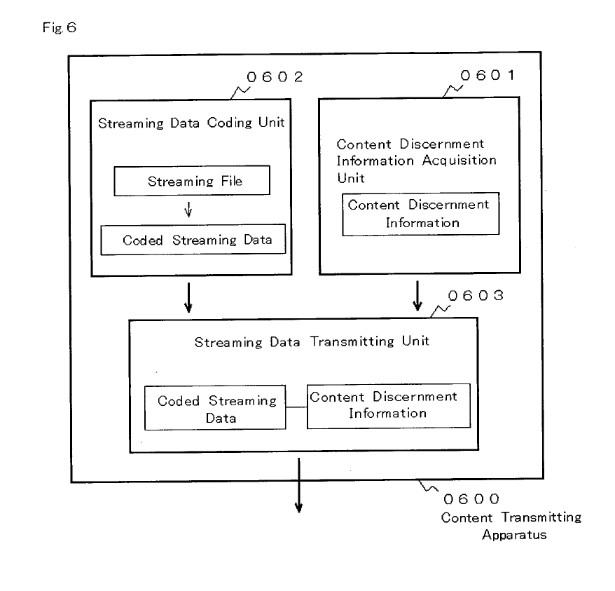

FIG. 6 shows a block diagram of the content transmitting apparatus described in the second embodiment.

The content transmitting apparatus (0600) in the present embodiment, shown in FIG. 6, comprises the content discernment information acquisition unit (0601), the streaming file data coding unit (0602), and the streaming file data transmitting unit (0603).

The content discernment information acquisition unit (0601) acquires the content discernment information. The acquisition of the content discernment information may be generated inside, but also may be acquired externally.

The streaming file data coding unit (0602) codes the streaming file to the coded streaming file data.

Although the streaming file is a file which comprises content with multiple combinations, the coded streaming file is called the coded stream data.

The term “coding” corresponds to conversion wherein it defines a suitable code system and codes. For example, it corresponds to the case that an analog data is coded to digital data, moreover in the case that they are converted to another form (MPEG form etc.). Besides, the term “coding” may correspond to encryption.

The streaming file data transmitting unit (0603) correlates and transmits the streaming file data coded in the streaming file data coding unit with the content discernment information acquired in said content discernment information acquisition unit.

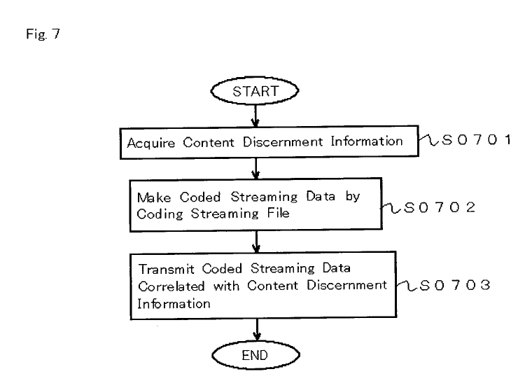

FIG. 7 demonstrates the process in the second embodiment. The transmitting-process in the present embodiment comprises the following three steps.

Firstly, the content discernment information is acquired (the content discernment information acquisition step; step S0701).

Secondly, the streaming file is coded to the coded streaming file data (the coding step of the streaming file data; step S0702).

Finally, the coded streaming file data is correlated with the content discernment information, and they are transmitted (the transmitting step of the coded stream file data; step S0703).

The content transmitting apparatus in the present embodiment may be united with the profile information transmitting apparatus described in the first embodiment, and may have the form of one apparatus. In this case, the profile information can be transmitted to make it possible to play back according to the combination of the streaming files with all the streaming files (coded streaming file data) which comprise the content.

In the embodiment described above, it is possible to adopt a constitution in which the content (streaming files of the content) comprised of streaming files such as music, narration, and images are once stored in the user terminal. Hence, even if users desire to play back music only, then the user desires to play back the content including narration and images, it will not be necessary to download those streaming files (coded streaming file data) since those streaming files have already been stored in the user terminal from the beginning.

Hence, the only thing the user, who desires to play back all the content after playing back music, has to do is to acquire the profile information for playback of those streaming files.

In addition, this profile information requires a lesser amount of sufficient data than the streaming files which comprise the content. Hence, in general, the time for downloading to acquire the profile information gets shorter, compared with the time for downloading to acquire the streaming files.

Thereby, from a user's view point, large files can be downloaded quickly.

Although users cannot realize that the narration and image information has already been stored in users' terminals (receiving apparatus etc.) when music is played back after downloading the profile information, they can be played back and the user can realize that downloading time is quite short.

If this system is used in the sale of the content, the content's seller will be able to sell the content at the moment that a user desires to purchase them. In addition, users can acquire the content easily (therefore, they can download it in a short time). Hence, the content's seller can take a business opportunity and can enjoy profits from it.

Moreover, in the case that all the streaming files, such as images and sounds, and the profile information for promotion are previously distributed, after then the profile information for playback of all the streaming files is distributed with the proviso of the fee collection process, it is possible to increase the effect of the advertisement by promotion. In addition to said effect, it is possible to respond to the user's request immediately.

Embodiments 3-5 will be described. The present embodiments are the content playback apparatus which performs the playback process based on the profile information.

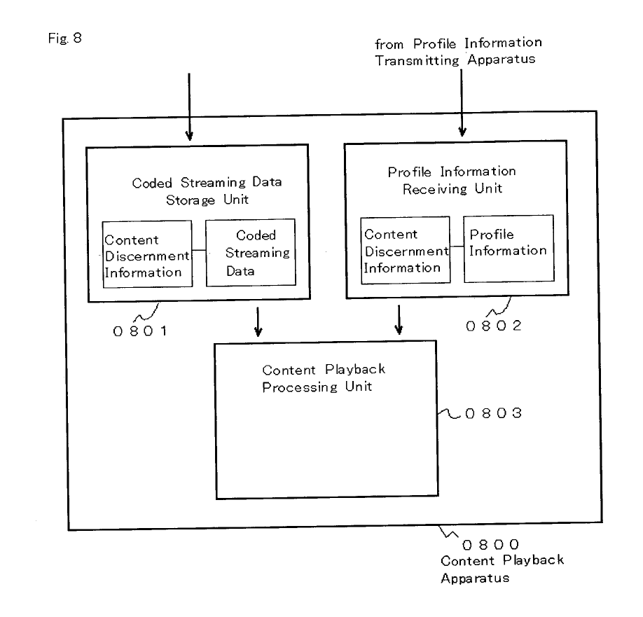

FIG. 8 illustrates an example of a block diagram of the content playback apparatus in the third embodiment.

The content playback apparatus (0800) comprises the storage unit for the coded streaming file data (0801), the profile information receiving unit (0802) and the content playback processing unit (0803).

The storage unit of the coded streaming data (0801) stores coded streaming file data. It may store the content discernment information correlated to the coded streaming file data. In this case, the coded streaming file data stored may be the data received which is transmitted from the content transmitting apparatus described in the second embodiment.

In addition, the term “storage” may correspond to a temporary storage for preservation. For example, the case that the coded streaming file data is accumulated for a split-second for playback of the streaming file.

The profile information receiving unit (0802) receives the profile information. The profile information receiving unit receives the profile information transmitted from the profile information transmitting apparatus described in the first embodiment and the content discernment information correlated to the profile information.

The content playback processing unit (0803) reconstructs the coded streaming file data stored in the coded streaming file data storage unit based on the profile information received in the profile information receiving unit and processes for playback of the content. In that case, the content playback processing unit processes for playback the same content according to the content discernment information correlated to the profile information and the coded streaming file data.

The term “recomposing” corresponds to reassembling. For example, it may include the process of selecting the coded streaming file data which corresponds to the profile information specified from the multiple coded streaming file data stored.

The term “process for playback” corresponds to all processes for playback. It corresponds to the process of decoding the coded streaming file data, the selection of playback means (existence of playback in a frame, selection of definition, etc.), the playback means selected, the process for outputting the data to the components for playback according to the area which can be played back, etc. Besides, for example, it corresponds to the process in which the content is composed of images and narrations from multiple streaming files, and said images and sounds are synchronized. It may also correspond to the case in which it is actually played back.

The content playback apparatus processes for playback according to selection of the content (sports news, or comedy movies etc.) from a menu in the content playback apparatus specifying the streaming file (music only, music and images etc.), and selecting the size of screen (full screen or small screen etc.).

The content playback apparatus in the third embodiment, allows users to select and play back streaming files (for example, music, images etc.) which suits his preference from multiple streaming files that comprise the content. Therefore, users can play back the streaming files immediately by selecting and executing the profile information including the information which enables to play back the streaming files of narration and images if they receive all the streaming files composing content even though they desire to play back the streaming files of narration and images after playback of only music streaming file etc. . . .

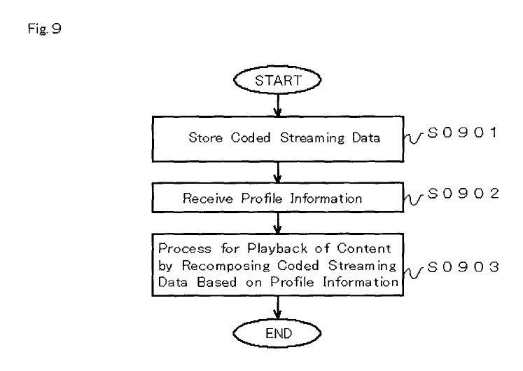

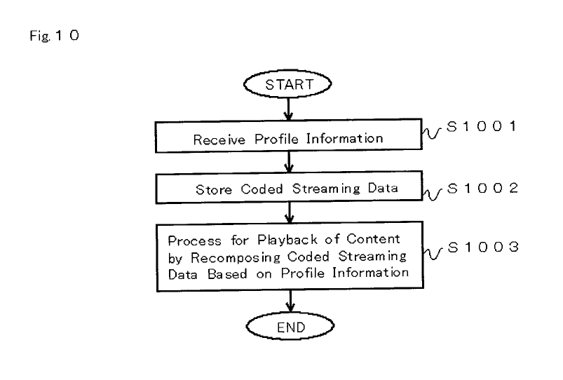

FIGS. 9 and 10 demonstrates the process in the third embodiment. Although the playback means in the third embodiment has a step of storing coded streaming file data and a step of receiving the profile information, it has a different effect described below by which step is performed in advance. Therefore, the first means for playback content that the storage process of the coded streaming file data is processed in advance will be described, and the second means for playback of content in which the profile information is received in advance will be described.

FIG. 9 demonstrates the storage process of the coded streaming file data as the first means for playback of content.

Firstly, the coded streaming file data is stored (the coded streaming file data storing step; step S0901). In this case, the coded streaming file data to be stored is transmitted from the content transmitting apparatus. The coded streaming file data stored like this can be confirmed in the state where it is listed.

The profile information is received (the profile information receiving step S0902) after said coded streaming file data storing step (step S0901).

The coded streaming file data stored in the coded streaming file data storing step based on the profile information which is transmitted in the profile information receiving step is reconstructed for the process for playback of content (the step of playback process of the content; step S0903).

FIG. 10 demonstrates the second means for playback of content in which the profile information is received in advance.

Firstly, the profile information is received (the profile information receiving step; the step S1001).

The coded streaming file data is stored (the streaming file data storing step; step S1002) after said profile information receiving step (S1001).

The coded streaming file data stored in the coded streaming file data storing step based on the profile information received in the profile information receiving step is reconstructed for the process for playback of content. (the step of playback process of the content; step S1003)

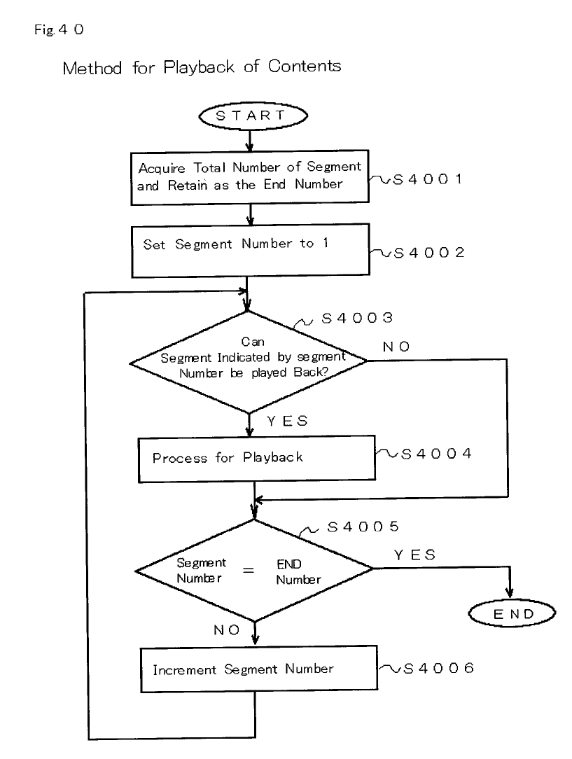

FIG. 40 demonstrates details of the playback means of the content.

Firstly, the total of the segment of the streaming files to be played back are required, and the total number acquired is retained as the end number. (step S4001)

Secondly, the segment number is set to 1. (step S4002) The segment number is the number divided and assigned from the head to the last of a streaming file which comprises the content. The segment number may be assigned to every pause and to every fixed time. For example, the segment number may be assigned by the maker of the streaming file.

The segment indicated by the segment number is determined whether it can be played back (step S4003). That it is possible to play back corresponds to both cases that the segment wherein it is possible to play back is not assigned, and the segment wherein it is possible to play back is assigned and indicated by segment number.

The case in which it is determined that the segment indicated by segment number is possible to be played back, it processes for playback (step S4004). For example, the segments are decoded individually, and the decoded data is output by the user-interface.

After processing step S4004, or after processing step S4003 when the area indicated by the segment number is determined that it cannot be played back, it is determined whether the segment number is equal to the end number, after processing step S4003 (step S4005). In the case that the segment number is equal to the end number, it means that it is processed to the end of the streaming file. On the contrary, in the case that the segment number is not equal to the end number, it's not processed to the end of the streaming file at that time.

When it is determined that the segment number is not equal to the end number, the increment of the segment number is carried out (step S4006). After that, it is back to step S4003, and is determined whether the area indicated by the segment number can be played back.

When the segment number is equal to the end number, it finishes the process.

In the fourth embodiment, firstly, the coded streaming file data storing process is performed in advance of receiving the profile information. The content is downloaded and stored during low volume hours, for example in the night time when the line is not busy, thereby making it possible for users to play back immediately after acquiring the profile information, even if the content has a large capacity. Moreover, it becomes possible to play back the content using the mobile playback device, since the substance of the content is acquired.

In the fifth embodiment, firstly, the profile information receiving process is performed in advance of the storing of the coded streaming file data. A lot of the profile information is received, and the user stores only the coded streaming file data which he is interested in and desires to play back, thereby it is beneficial that hardware resources can be used efficiently.

The sixth embodiment is the profile information transmitting apparatus which is characterized by receiving the profile information request described in the first embodiment.

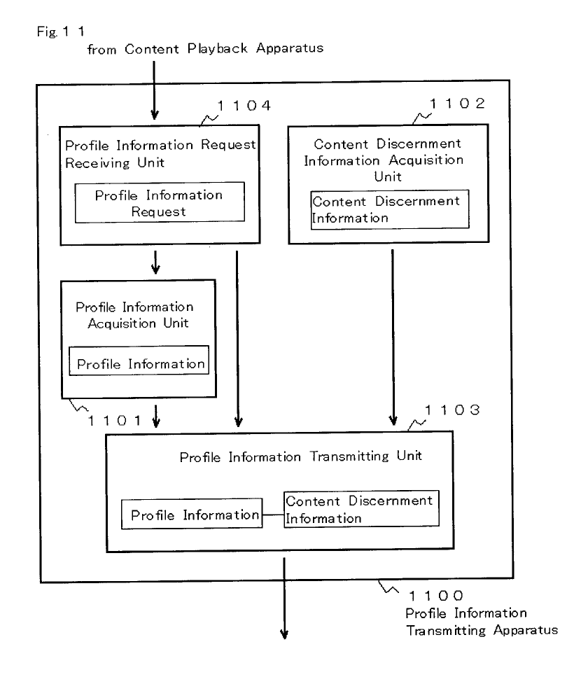

FIG. 11 illustrates an example of a block diagram of the profile information transmitting apparatus in the sixth embodiment.

The profile information transmitting apparatus in the present embodiment shown in FIG. 11 comprises the profile information acquisition unit (1101), the content discernment information acquisition unit (1102), the profile information transmitting unit (1103), and the profile information request receiving unit (1104). The profile information acquisition unit (1101), the content discernment information acquisition unit (1102), and the profile information transmitting unit (1103) are the same as the first embodiment.

The profile information request receiving unit (1104) processes for receiving a request of profile information. The term profile information request corresponds to a request of transmitting the profile information. The profile information request is transferred from the content playback apparatus to the profile information transmitting apparatus, and requests playback by specifying the streaming file (for example, a music streaming file) included in the content. The profile information based on this profile information request is acquired, thereby making it possible to play back the streaming file which is requested.

The profile information request may be transmitted to the profile information acquisition unit (1101) to acquire the profile information based on the request, and may be transmitted to the profile information transmitting unit (1103) to transmit the profile information selected to suit the request from multiple profile information. In this case, the profile information storage unit wherein multiple profiles are stored to be selected and to be transmitted may be found.

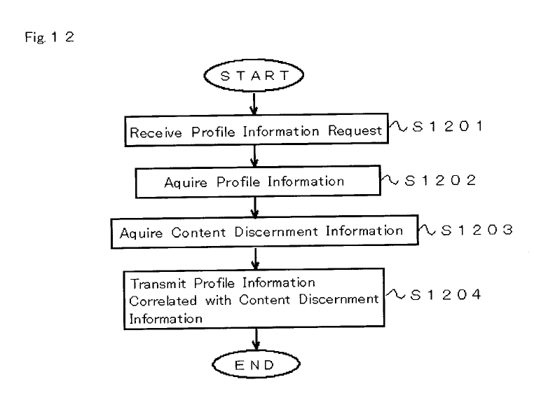

FIG. 12 demonstrates the process in the sixth embodiment. The means of transmitting the profile information comprises these following steps;

The profile information request is received (step S1201) The profile information is acquired (step S1202). The profile information may be acquired based on the profile information request which is received in step S1201.

The content discernment information is acquired (step S1203).

Finally, the profile information correlated with the content discernment information is transmitted (step S1204). The profile information selected based on the profile information request received in step S1201 may be transmitted.

The seventh embodiment will be described. The present embodiment is the content playback apparatus described in the third embodiment characterized by transmitting the profile information request.

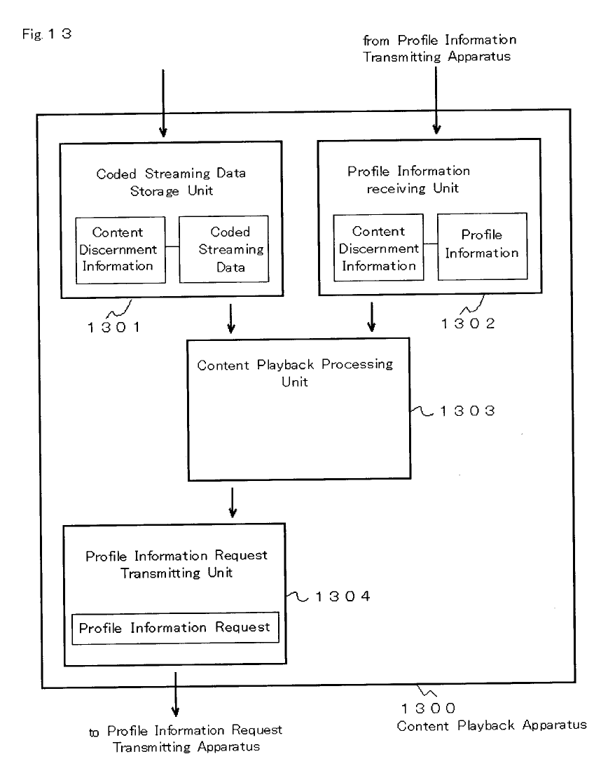

FIG. 13 shows a block diagram of the content playback apparatus in the seventh embodiment.

The content playback apparatus in the present embodiment shown in FIG. 13 (1300) comprises the coded streaming file data storage unit (1301), the profile information receiving unit (1302), the content playback processing unit (1303), and the profile information request transmitting unit (1304). The coded streaming file data storage unit (1301), the profile information receiving unit (1302), and the content playback processing unit (1303) are the same as that described in the third embodiment.

The profile information request transmitting unit (1304) processes for transmitting the profile information request. The profile information request is transmitted to the profile information transmitting unit in the sixth embodiment to express the request of the user.

The content playback apparatus specifies the streaming files (for example, a music streaming file) included in the content, thereby expressing playback request by transmitting the profile information request. By receiving the profile information based on the profile information request from the profile information transmitting apparatus, it becomes possible to play back the streaming file requested.

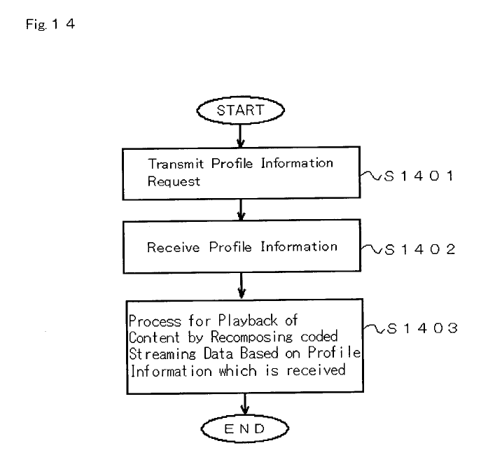

FIG. 14 demonstrates the process in the seventh embodiment. The means for playback of content for transmitting the profile information request comprises the following steps;

Firstly, it is processed for transmitting the profile information request. It specifies the content discernment information and transmits the profile information request (step S1401).

Secondly, the profile information transmitted from the profile information transmitting apparatus is received according to the profile information (step S1402).

Finally, the coded streaming file data is reconstructed based on the profile information received and the process for playback of content is performed (step S1403).

The content playback apparatus described in the seventh embodiment (in this case, it is synonymous with the user) transmits the user's request of viewing and listening to the content or the streaming file which is a part of the content and the profile information transmitting apparatus described in the sixth embodiment transmits the profile information based on that request. Thereby it becomes beneficial that the user can view and listen to the content actively according to the user's request.

The eighth embodiment will be described. The present embodiment, described in the seventh embodiment, is the content playback apparatus characterized by transmitting the profile information request with the proviso of the fee collection process.

FIG. 13 shows an example of a block diagram in the eighth embodiment.

The content playback apparatus in the present embodiment, shown in FIG. 13, (1300) comprises the coded streaming file data storage unit (1301), the profile information receiving unit (1302), the content playback processing unit (1303), and the profile information request transmitting unit (1304). The coded streaming file data storage unit (1301), the profile information receiving unit (1302) and the content playback processing unit (1303) are the same as described in the third embodiment.

The profile information request transmitting unit (1304) processes for transmitting the profile information with the proviso of the fee collection process.

The term “fee collection process” corresponds to the process for preparing a charge. Therefore, it is not necessary to transfer money. It corresponds to the case that, for example, a bank account is checked at the time of transmission of the profile information, and the profile information requested from the profile information transmitting apparatus is transmitted.

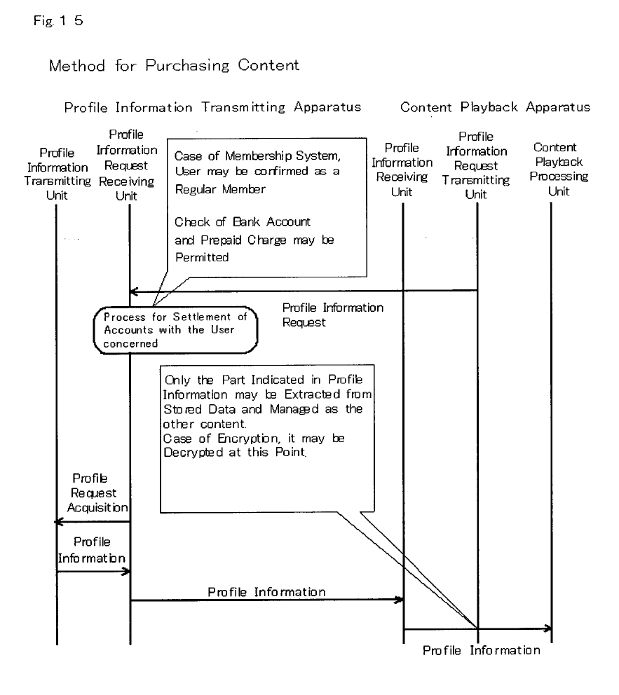

FIG. 15 illustrates a general structure of the fee collection process. The content playback apparatus is on the right and the profile transmitting apparatus is on the left.

Here, the profile information request transmitting unit in the content playback apparatus transmits the request of purchase for the content (the profile information request), and the profile information request receiving unit in the profile information transmitting unit receives the request, thereby processing for account settlement with the user (the content playback apparatus) who made the request.

The process for account settlement may be from a prepaid one or may be a charge to a bank account. Besides, as for regular members, when a user desires to purchase the content without a charge, it may be confirmed whether he is a regular member.

In the profile information transmitting apparatus, the profile information acquisition request is transmitted from the profile information request receiving unit to the profile information transmitting unit, according to it, the profile information is transmitted from the profile information transmitting unit to the profile information request receiving unit. After that, the profile information is received in the profile information receiving unit in the content playback apparatus and transmitted to the content playback processing unit. Here the specified streaming file indicated in the profile information is processed for playback.

The ninth embodiment will be described. The present embodiment is the content playback apparatus, described in the first embodiment, characterized by that said profile information is the information on playback of the content according to the combination of the streaming files. Therefore, as for this ninth embodiment, it will be briefly mentioned hereinafter since it is already described in the first embodiment.

An example of a block diagram of the content playback apparatus in the ninth embodiment is the same as which is shown in FIG. 2.

The profile information transmitting apparatus in the present embodiment, shown in FIG. 2, (0200) comprises the profile information acquisition unit (0201), the content discernment information acquisition unit (0202), and the profile information transmitting unit (0203). The content discernment information acquisition unit (0202) and the profile information transmitting unit (0203) are the same that is already described in the first embodiment.

The profile information acquired in the profile information acquisition unit (0201) is the information on the playback of the content according to, at least, any one of the sound streaming files and the image streaming files. For example, the profile information may be comprised of only the image streaming files, and may comprise both of the sound streaming files and the image streaming files. In the case that the image streaming files are the requirements for composition, it will be necessary to have a screen as a playback apparatus. In the case that only the sound streaming files are the requirements for composition, connecting to MD etc., it will be possible to play back. Thereby it makes it possible to prepare for playback.

The tenth embodiment will be described. The present embodiment is the content playback apparatus, described in the third embodiment, characterized by having the key acquisition unit for acquiring the key to decrypt the encrypted profile information.

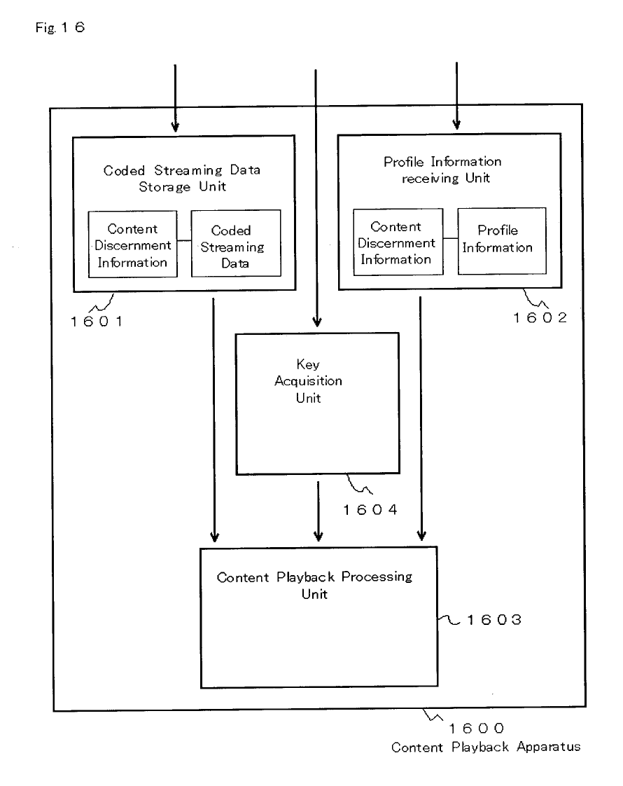

FIG. 16 shows an example of a block diagram of the content playback apparatus in the tenth embodiment.

The content playback apparatus, shown in FIG. 16, (1600) comprises the coded streaming file data storage unit (1601), the profile information receiving unit (1602), the content playback processing unit (1603), and the key acquisition unit (1604). The coded streaming file data storage unit (1601), and the content playback processing unit (1603) are already described in the third embodiment.

The profile information receiving unit (1602) receives the profile information which is encrypted by the key. The profile information is encrypted by the key, thereby making it possible to restrict use to users who are authorized to decrypt the profile information. The whole or the part of profile information may be encrypted.

The key acquisition unit (1604) processes for acquiring the key to decrypt the profile information according to the profile information. For example, the key is transmitted with the profile information from the profile information transmitting apparatus. Using the key, it becomes possible to decrypt the profile information and to play back the content using the profile information that is decrypted.

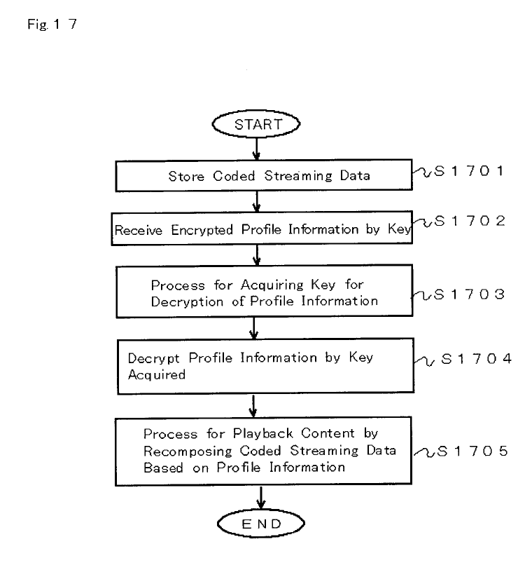

FIG. 17 demonstrates the process in the tenth embodiment. The means for playback of the content comprises the following steps;

The coded streaming file data is stored. (The coded streaming file data storage step S1701) The profile information encrypted by the key is received. (The profile information receiving step S1702) Here, step S1701 and step S1702 may be in a reverse order.

It performs the processes for acquiring the key to decrypt the profile information. (The key acquisition step S1703) The profile information is decrypted by the key acquired. (step S1704)

It recomposes the coded streaming file data stored in the coded streaming file data storage step based on the profile information received in the profile information receiving step and performs the processes for playback of the content (the content playback processing step S1705).

The eleventh embodiment will be described. The present embodiment is the content playback apparatus, described in the third embodiment, characterized by having the key acquisition unit for acquiring the key with the proviso of the fee collection process.

FIG. 16 has already shown an example of a block diagram of the content playback apparatus in the eleventh embodiment.

The content playback apparatus (1600) in the present embodiment, shown in FIG. 16, comprises the coded streaming file data storage unit (1601), the profile information receiving unit (1602), the content playback processing unit (1603), and the key acquisition unit (1604). The coded streaming file data storage unit (1601), the profile information receiving unit (1602), and the content playback processing unit (1603) are already described in the tenth embodiment.

The key acquisition unit (1604) performs the processes for acquiring the key to decrypt the profile information according to the profile information with the proviso of the fee collection process. Hence, the key can be acquired by purchasing it. It becomes possible to decrypt the profile information by the key acquired, and to play back the content by the profile information decrypted.

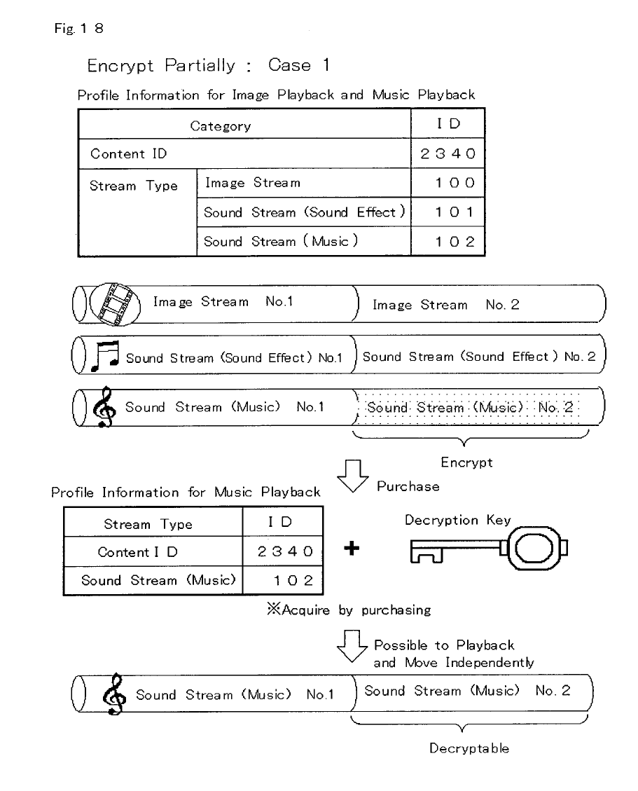

FIG. 18 shows the first example of the means for acquiring the key. In FIG. 18, the case is supposed that only the second music streaming file, a part of the music streaming file, is encrypted. Since the other part is not encrypted, users can view and listen to it freely. In detail, the case is supposed that only the first part of the music, which is composed of two parts, is viewed and listened to. When the user who viewed and listened to only the first part, desires to view and listen to the second part, which is the sequel to the first part, he decrypts the second music streaming file using the profile information of the second music streaming file. However, it is necessary to purchase the key to decrypt the profile information since that profile information is encrypted. If the user acquires the key, he can play back the first music streaming file in the state it is, and can play back the second one after it is decoded using the decrypted profile information. As described hereinbefore, it becomes possible to play back and move the music streaming file independently.

Here, although the profile information is decrypted by the key acquired, there may be the case that the second music streaming file itself is decrypted. Moreover there may be the case that the second music streaming file is decrypted using both of the key acquired and the profile information.

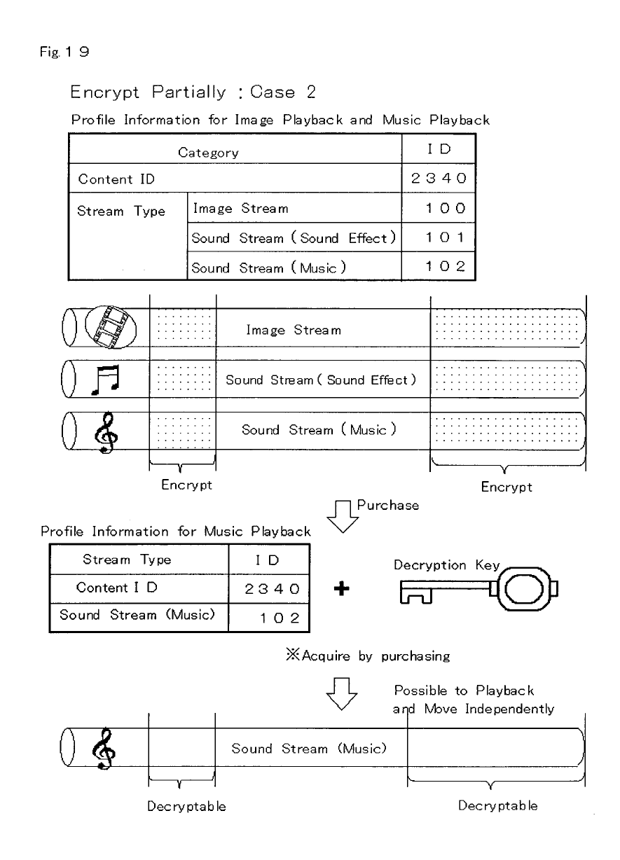

FIG. 19 illustrates the second example of the means for acquiring the key. In FIG. 19, the case is supposed that multiple content is partitioned off equally with time, and part of them are encrypted. The user can watch the other part which is not encrypted. In detail, the case is supposed that it is possible to watch only a part of the movie (preview). When the user who watched it desires to listen to its whole sound track, he decodes the music streaming file using the profile information of the music streaming file. However, it is necessary to purchase the key to decrypt the profile information since that profile information is encrypted. If the user purchases the key, he can play back the part of the profile information of music which is not encrypted in the state it is, and can play back the part of it which is encrypted after decoding it using the profile information decrypted by the key acquired.

The twelfth embodiment will be described. The present embodiment is the content playback apparatus, described in the tenth embodiment, which is characterized by having the key request information transmitting unit to require the key.

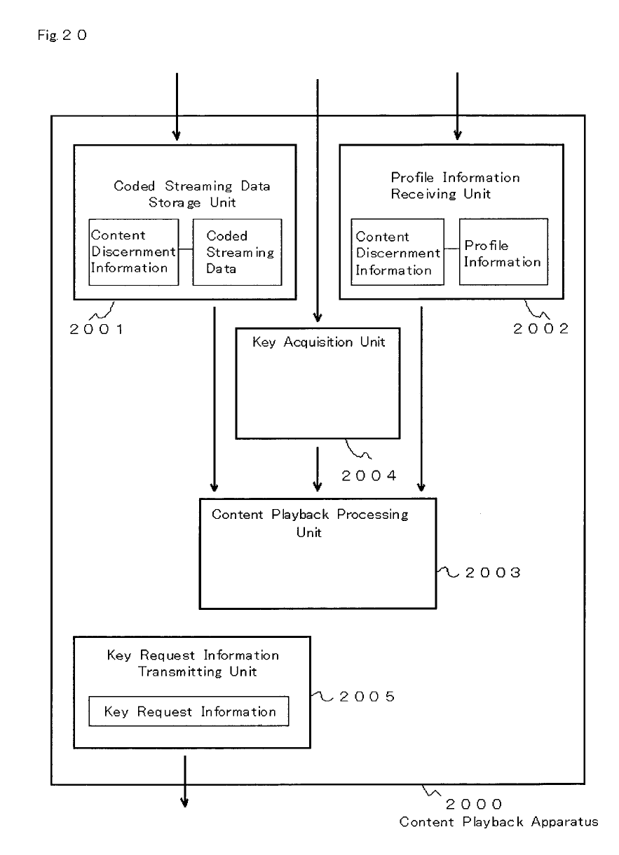

FIG. 20 shows an example of a block diagram of the content playback apparatus in the twelfth embodiment.

The content playback apparatus in the present embodiment, shown in FIG. 20 (2000), comprises the coded streaming file data storage unit (2001), the profile information receiving unit (2002), the content playback processing unit (2003), the key acquisition unit (2004), and the key request information transmitting unit (2005). The coded streaming file data storage unit (2001), the profile information receiving unit (2002), the content playback processing unit (2003), and the key acquisition unit (2004) are already described in the tenth embodiment.

The key request information transmitting unit (2005) performs the processes for transmitting the key request information. The key request information is the information to request the key. In detail, it corresponds to the information to request the key indirectly, specifying the streaming file which is desired to be viewed and listened to. The key may be acquired in the key acquisition unit (2004) according to the request transmitted to the profile information transmitting apparatus etc.

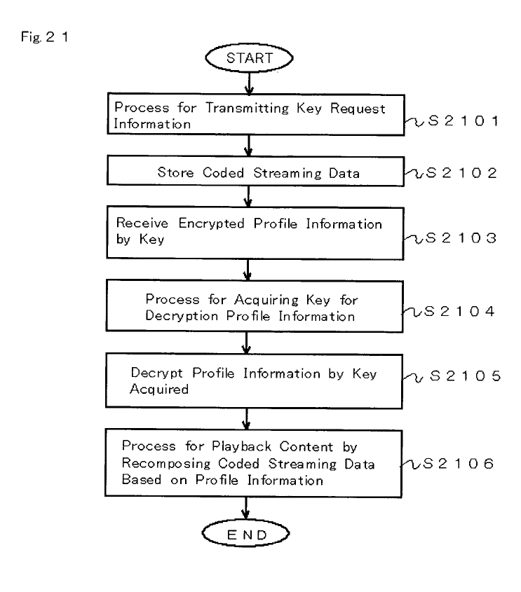

FIG. 21 demonstrates the process in the twelfth embodiment. The means for playback of the content in the twelfth embodiment comprises the following steps;

It performs the processes for transmitting the key request information (The key request information transmitting step S2102).

The coded streaming file data is stored. (The coded streaming file data storage step S2102) The profile information encrypted by the key is received (The profile information receiving step S2103). Here the order of step S2102 and step S2103 may be reversed.

It performs the processes for acquiring the key to decrypt the profile information received (The key acquisition step S2104). The key acquired is transmitted from the profile information transmitting apparatus according to the key request information transmitted in step S2101.

The profile information is decrypted using the key acquired. (step S2105)

It reconstructs the coded streaming file data which was stored in the coded streaming file data storage step based on the profile information, and for playback of the content.

The thirteenth embodiment will be described. The present embodiment is the content playback apparatus characterized by having the key request transmitting apparatus which requires the key with the proviso of the fee collection process.

FIG. 20 shows an example of a block diagram of the content playback apparatus in the thirteenth embodiment.

The content playback apparatus in the present embodiment, shown in FIG. 20 (2000), comprises the coded streaming file data storage unit (2001), the profile information receiving unit (2002), the content playback processing unit (2003), the key acquisition unit (2004), and the key request information transmitting unit (2005).

The key request information transmitting unit (2005) performs the processes for transmitting the key request information with the proviso of the fee collection process.

The transmitting of the key request information becomes impossible without processing a charge to the user. If the key is not required, thereby making it impossible to acquire the key, the profile information will not be decoded and the content will not be played back.

The profile information is encrypted, thereby making it possible to conceal a part of the content, even though its whole content was distributed to the user.

It is easy to add and change the part of the content specified, since it is specified not to the content but to the profile information. Moreover it is beneficial to the user that it is not necessary to download the whole content again after downloading its sample as in the conventional way, since the content can be played back by acquiring only the key.

In addition, it is profitable for the user to spend very little time to acquire the key, since the amount of data is less than the profile information. The case in which actual dealings are conducted by a dealing of a key, it is beneficial that burdens for both the dealer and user sides are suppressed to the minimum since the amount of data of the key is small.

Moreover, it is convenient for a user to acquire the key according to his demand.

The fourteenth embodiment will be described. The present embodiment is the content playback apparatus, described in the third embodiment, which is characterized by processing for playback with reconstructing more than one streaming file data distributed-allocated.

An example of a block diagram of the content playback apparatus in the fourteenth embodiment is already shown in FIG. 8

The content playback apparatus in the present embodiment, shown in FIG. 8 (0800) comprises the coded streaming file data storage unit (0801), the profile information receiving unit (0802) and the content playback processing unit (0803).

The coded streaming file data storage unit (0801) stores coded streaming file data distributed and allocated with multiple streaming file data.

The term “distributed-allocation” corresponds to allocating multiple streaming file data discretely. For example, it is possible that the coded streaming file data cannot help being stored into fragments on a congested line, even though it is the one content which comprises streaming files of images and sounds. In detail, each streaming file is stored into fragments in the order of playback of the content. In spite of this, the content can be recomposed of the necessary streaming file data in the content playback processing unit.

The content playback processing unit (0803) recomposes the necessary streaming file data from said coded streaming file data based on said profile information.

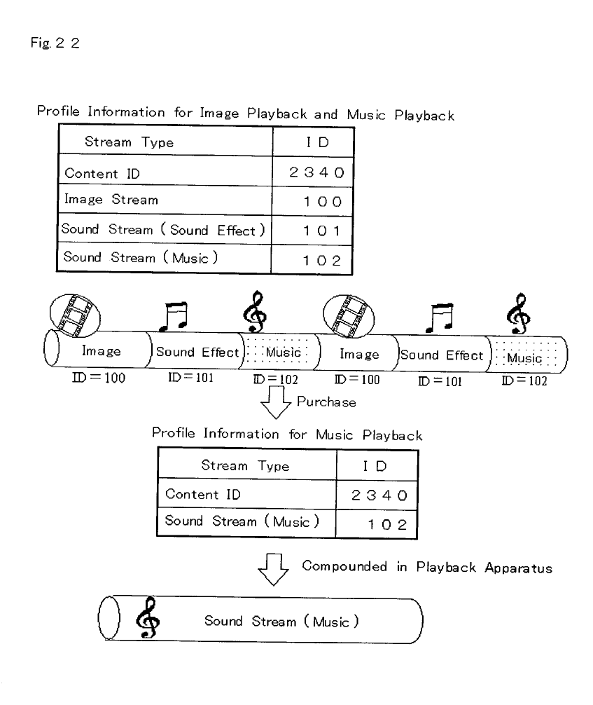

FIG. 22 illustrates a concept of the process for recomposing only the necessary coded streaming file data. As shown in Fig., more than one coded streaming file data (images, sound effects, music) are stored apart. When the user desires to listen to music, he acquires the profile information for playback of music. Here the same ID is assigned to the same coded streaming file data, thereby making it possible to discern which part of the coded streaming file data it is. Hence, it becomes possible to recompose specific streaming file data by extracting, collecting, and connecting some parts of the coded streaming file data in the content playback apparatus, thereby making one content of music.

In the case that the content playback apparatus cannot store a large number of files at once due to of its low capacity, distributing and allocating is beneficial. Hence, in the case of content with large capacity, it is beneficial that streaming files are downloaded smoothly since it is possible to store each of them into fragments, for example, during the night time when lines are not busy.

Moreover, it is possible to move streaming files to the movable media by integrating and allocating streaming files distributed and allocated into one file.

In addition, when each streaming file is stored into fragments, the content is distributed and allocated in order of playback, thereby making it possible to prepare for playback of the latter part while simultaneously playing back the former part.

The fifteenth embodiment will be described. The present embodiment is the content playback apparatus which performs the processes for playback of the content data, layered by scalability.

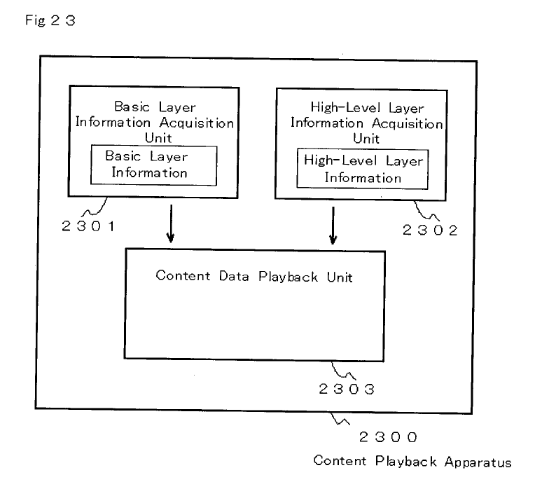

FIG. 23 shows an example of a block diagram of the content playback apparatus in the fifteenth embodiment.

The content playback apparatus in the present embodiment, shown in FIG. 23, comprises the content data playback unit (2301), the basic layer information acquisition unit (2302), and the high-level layer information acquisition unit (2303).

The content data playback unit (2301) plays back the content data which is layered by scalability. Therefore, the basic layer information which is necessary for playback of the content or the both of the basic layer information for playback at high scalability of the content is played back.

The term “scalability” corresponds to a parameter for coding to acquire a bit streaming file on the receiving side according to the resolution of the receiving set and the condition of the communication network. Using the scalability, for example, it becomes possible to use resolution from low level to high level, and to use bit rate from low level to high level according to the conditions at that time.

The term “basic layer information” corresponds to the basic data which is necessary for playback of the content. Besides, the term high-level layer information corresponds to data used for improving the quality of images and increasing the efficiency of transmission to play back the content. Although the basic layer information makes it possible to play back the content by itself, it has a disadvantage with low-definition images. However the high-level layer information cannot play back the content by itself. Here by combining the basic layer information with the high-level layer information, for example, it becomes possible to play back at a high rate and at a high resolution.

The basic layer information acquisition unit (2302) acquires said basic layer information. The basic layer information acquired is transmitted to the content data playback unit.

The high-level layer information acquisition unit (2303) acquires said high-level layer information. The high-level layer information acquired is transmitted to the content data playback unit.

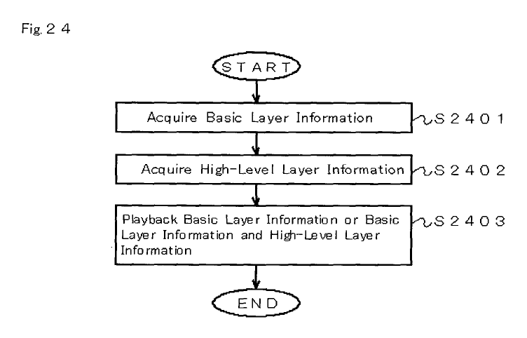

FIG. 24 demonstrates the process in the fifteenth embodiment. The process of playback of the content is comprised of the following steps;

The basic layer information is acquired. (the basic layer information acquisition step S2401) The high-level layer information is acquired. (The high-level layer information acquisition step S2402) S2401 and S2402 may be reversed in order.

The basic layer information or the both of the basic layer information and the high-level layer information are played back. (The content data playback step S2403)

The sixteenth embodiment is the content playback apparatus, described in the fifteenth embodiment, characterized by that the scalability is time and/or space scalability, and/or SNR (Signal to Noise Ratio) scalability.

An example of the content playback apparatus in the sixteenth embodiment is already shown in FIG. 23.

The content playback apparatus in the present embodiment (2300), shown in FIG. 23, comprises the content data playback unit (2301), the basic layer information acquisition unit (2302) and the high-level layer information acquisition unit (2303). The process of each part was described in the fifteenth embodiment.

The content data playback unit (2301) is characterized by that when the content data layered by the scalability is played back, the scalability corresponds to time and/or space scalability, and/or SNR (Signal to Noise Ratio) scalability.

The scalability of space is a parameter which shows the degree of space resolution (the number of pixels). The layer which has a small resolution of space is the basic layer, and the layer which has a large resolution of space is the high-level layer. The high-level layer information predicts not only multiple high-level layer information, but also by the information of images which expand the basic layer, thereby making it possible to code more efficiently than if two image sequences are coded separately.

The scalability of time is a parameter which shows the degree of time resolution (the number of frames). The layer which has a small time resolution is the basic layer, and the layer which has a large time resolution is the high-class layer. It transmits those from which frame frequency differs efficiently.

The SNR scalability is a parameter which shows the degree of the quantization accuracy of the DCT coefficient. SNR (Signal to Noise Ratio) is the ratio of signal to noise. It can simultaneously and efficiently transmit two images which have different qualities.

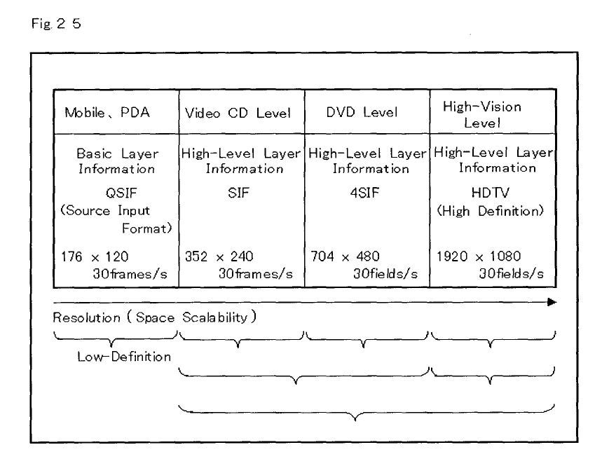

FIG. 25 illustrates the layer information classified by resolution. Here the basic layer information and the high-level layer information are shown in three levels. The basic layer information is the lowest-definition, and it gets higher in definition in the order of Video CD, DVD and Hi-vision. Since it is impossible to play back by only the high-level layer information, it can be combined with the basic layer information. The basic layer information can be combined with the high-level layer information at Video-CD definition level, in addition, the high-level layer information at DVD definition level can be combined with them.

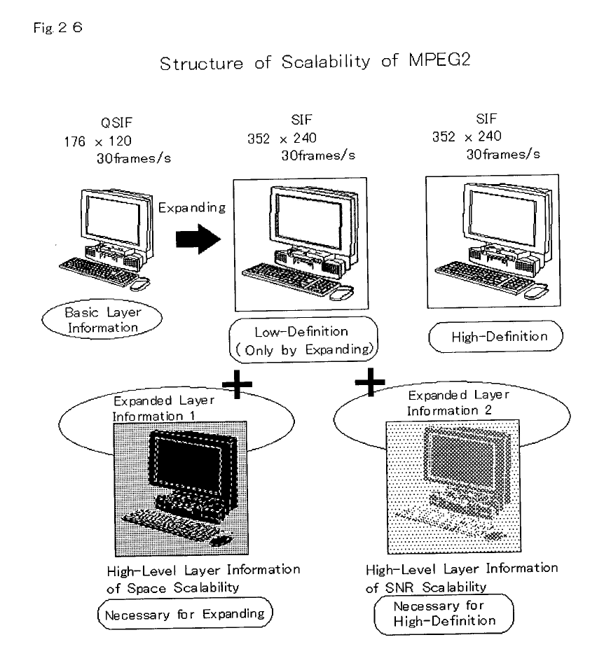

FIG. 26 illustrates the structure of scalability. Even if the high-level layer information is acquired by expanding the basic layer information, the quality of images will be low. It makes the quality of images high by adding the high-level layer information as the expanded layer to the layer information acquired by expanding.

The content data is layered and coded by scalability, and the basic layer information which is necessary for playback of the content and the high-level layer information for improving the quality of images are acquired based on necessity. Thereby it becomes possible to take the best means for playback of the content.

The seventeenth embodiment is the content playback apparatus, described in the fifteenth embodiment, characterized by that the basic layer information used for the preview of the content.

An example of the block diagram of the content playback apparatus in the seventeenth embodiment is already shown in FIG. 23.

The content playback apparatus (2300) in the present embodiment, shown in FIG. 23, comprises the content data playback unit (2301), the basic layer information acquisition unit (2302), and the high-level layer information acquisition unit (2303). The process of each unit was described in the fifteenth embodiment.

The basic layer information acquired in the basic layer information acquisition unit (2302), is the content data used for preview of the content. Although the image which is played back only by the basic layer information is low-definition, when it is used for preview of the content, it is allowed to be low-definition, and the basic layer information is used for preview. Users view and listen to this preview, and when the user desires to view and listen to the higher-definition content, the high-level layer information is used. The usage of the high-level layer information will be described in the eighteenth embodiment.

The eighteenth embodiment is the content playback apparatus, described in the seventeenth embodiment, characterized by having the fee collection processing unit for high-level layer information.

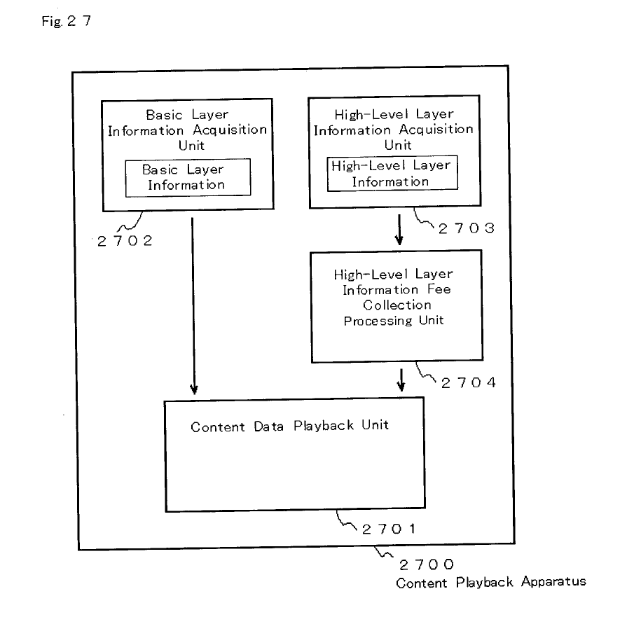

An example of the block diagram of the content playback apparatus in the eighteenth embodiment is shown in FIG. 27.

The content playback apparatus in the present embodiment, shown in FIG. 27, (2700) comprises the content data playback unit (2701), the basic layer information acquisition unit (2702), the high-level layer information acquisition unit (2703), and the fee collection processing unit for high-level layer information (2704). The content data playback unit (2701), the basic layer information acquisition unit (2702), and the high-level layer information acquisition unit (2703) were described in the fifteenth embodiment.

The fee collection processing unit for high-level layer information (2704) performs the processes for making it possible to play back the content using the high-level layer information acquired in said high-level layer information acquisition unit with the proviso of the fee collection process.

In the seventeenth embodiment, when users desire to view and listen to the content at higher-definition after viewing and listening to the preview, the content is played back using the high-level layer information.

In detail, users download the content of a low-definition movie etc. (the basic layer information) and tries viewing and listening to it. If the user likes, he can purchase the high-definition content (the high-class layer information). The basic layer information is about 200 kbps and after downloading the basic layer information, the user purchases the high-level layer information which is Video-CD definition level (about 800 kbps) and downloads it. Thereby it becomes possible to play back a movie which includes them all at Video-CD definition level at 1 Mbps. Furthermore, when the user desires to view and listen in higher-definition, he can play back a movie at DVD definition level at 5 Mbps total by purchasing the high-level layer information at DVD definition level (4 Mbps) separately. In the case that the user purchases the content, described hereinbefore, it is not necessary to finish the fee collection process, and is allowed to be the process for fee collection process.

The nineteenth embodiment is the content playback apparatus, described in the seventeenth embodiment, characterized by having the fee collection processing unit for the basic layer information for playback using the basic layer information.

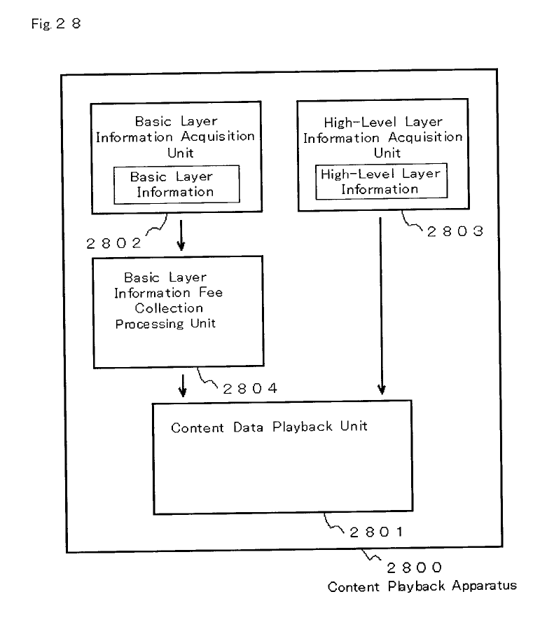

FIG. 28 shows an example of the block diagram of the content playback apparatus in the nineteenth embodiment.

The content playback apparatus in the present embodiment, shown in FIG. 28, comprises the content data playback unit (2801), the basic layer information acquisition unit (2802), the high-level layer information acquisition unit (2803), and the fee collection processing unit for the basic layer information (2804). The content data playback apparatus (2801), the basic layer information acquisition unit (2802), and the high-level layer information acquisition unit (2803) were described in the fifteenth embodiment.

The fee collection processing unit for the basic layer information (2804) processes for making it possible to play back using the basic layer information which is acquired in said basic layer information acquisition unit with the proviso of the fee collection process. In the case that the basic layer information is used, it may play back with the proviso of the fee collection process. In this case, although the high-level layer information is already downloaded, the content cannot be played back since there is no basic layer information. Hence, it becomes possible to play back at high-definition by compounding the basic layer information suitably, after purchasing and acquiring it. In this case, although it becomes possible to play back at high-definition by the high-level layer information, the fee for playback of the basic layer information can be lower than the fee for playback of the high-level layer information in the eighteenth embodiment.

It is beneficial that the user can view and listen to the content by his preferred definition selected from multiple high-level layer information.

The twentieth embodiment is the content playback apparatus, described in the fifteenth embodiment, characterized by that the basic layer information acquisition unit acquiring the basic layer information which is broadcast.

An example of the block diagram of the content playback apparatus in the twentieth embodiment is already shown in FIG. 23.

The content playback apparatus (2300) comprises the content data playback unit (2301), the basic layer information acquisition unit (2302), and the high-level layer information acquisition unit (2303). The process of each unit was already described in the fifteenth embodiment.

The basic layer information acquisition unit (2302) acquires the basic layer information unit which is broadcast. The term “broadcast” corresponds to transmitting sounds and images to a transmitting apparatus on a radio wave for the purpose of being viewed and listened to by many people at the same time. It may include the broadcasting not only by wireless means but also by cable. Moreover, it may include the internet broadcasting (a service which serves multimedia information such as sounds, animations, etc. on the internet).

In detail, the low-definition content, which is the content data of the basic layer information, are broadcast. It becomes possible for users to view and listen to the high-definition content by combining the basic layer information broadcast with the high-level layer information already preserved. The means for acquiring the high-level layer information will be described hereinafter.

The twenty-first embodiment is the content playback apparatus, described in the twentieth embodiment, characterized by that the high-level layer information acquisition unit acquires the high-level layer information through the communication network.

An example of a block diagram of the content playback apparatus in the twenty-first embodiment is already shown in FIG. 23.

The content playback apparatus in the present embodiment, shown in FIG. 23, (2300) comprises the content data playback unit (2301), the basic layer information acquisition unit (2302), and the high-level layer information acquisition unit (2303). The process of each unit was described in the twentieth embodiment.

The high-level layer information acquisition unit (2303) acquires the high-level layer information through the communication network. The term communication corresponds to transmitting signals, such as sounds and images etc., converted to electric signals. In general, a transmission is performed in the relation of one to one. In the twentieth embodiment, the high-level layer information is transmitted in advance of broadcasting the basic layer information. In the content playback apparatus, the basic layer information is received by broadcasting and is compounded with the high-level layer information acquired through the communication network. Although the content is low-definition in the broadcast, the high-definition content can be viewed and listened to by purchasing the high-level layer information.

The twenty-second embodiment is the content playback apparatus described in the fifteenth embodiment characterized by that the basic layer information acquisition unit acquires the basic layer information through the communication network.

An example of the block diagram of the content playback apparatus in the twenty-second embodiment is already shown in FIG. 23.

The content playback apparatus in the present embodiment, shown in FIG. 23, comprises the content data playback unit (2301), the basic layer information acquisition unit (2302), and the high-level layer information acquisition unit (2303). The process of each unit was described in the fifteenth embodiment.

The basic layer information acquisition unit (2302) acquires the basic layer information through the communication network. The basic layer information which is necessary to play back the content is downloaded through the communication network. In this case, it is impossible to play back the content since there is no basic layer information, even if the high-level layer information is downloaded. Therefore, it becomes possible to play back the high-definition content by compounding the basic layer information with the high-level layer information after the basic layer information is purchased and acquired. The means for acquiring the high-level layer information will be described hereinafter.

The twenty-third embodiment is the content playback apparatus described in the twenty-second embodiment characterized by that the high-level layer information acquisition unit acquiring the high-level layer information broadcast.

An example of the block diagram of the content playback apparatus in the twenty-third embodiment is already shown in FIG. 23.

The content playback apparatus (2300) comprises the content data playback unit (2301), the basic layer information acquisition unit (2302) and the high-level layer information acquisition unit (2303). The process of each unit was described in the fifteenth embodiment.

The high-level layer information acquisition unit (2303) acquires the high-level layer information broadcast. In the content playback apparatus, the high-level layer information is received by broadcasting, and is combined with the basic layer information acquired through the communication network. Although users cannot view and listen to the high-definition content only by the broadcasting, it becomes possible to play back, view, and listen to the high-definition content by purchasing the basic layer information.

In the case that the basic layer information is distributed by broadcasting and the high-level layer information is distributed through the communication network, it is possible to listen to and view. In addition, it is beneficial to respond individually to the case in which the user desires to play back higher-definition content.

On the contrary, that the high-level layer information is acquired by broadcasting and the basic layer information is acquired through the communication network, if the basic layer information is not acquired, the user will not be able to view or listen to the content. Therefore it is beneficial to the mode that only the specific user is made to be listened to or viewed.

The twenty-fourth embodiment is the content playback apparatus that has the layer information storage unit which stores the basic layer information or the high-level layer information.

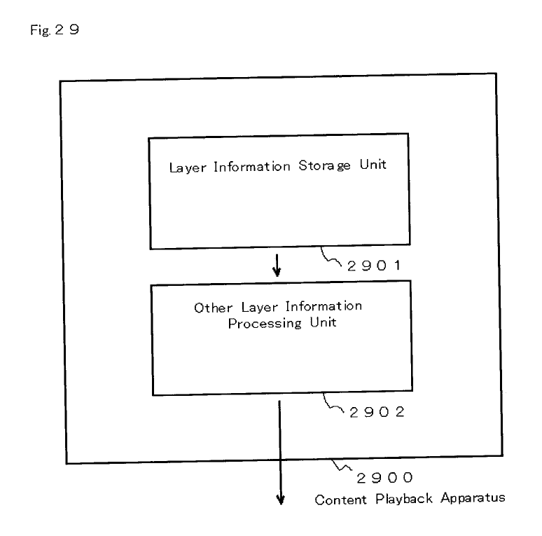

An example of the block diagram of the content playback apparatus in the twenty-fourth embodiment is shown in FIG. 29.

The content playback apparatus in the present embodiment, shown in FIG. 29, (2900) comprises the layer information storage unit (2901) and the other layer information processing unit (2902).

The layer information storage unit (2901) stores the said basic layer information or the high-level layer information.

The other layer information processing unit (2902) acquires the high-level layer information which is the information of the different layer from the information stored in said layer information storage unit. Hence, in the case that the basic layer information is stored in the layer information storage unit, the high-level layer information is acquired and the content is played back. On the contrary, that the high-level layer information is stored in the layer information storage unit, the basic layer information is acquired and the content is played back. Besides, it is possible to compose the layer information stored in advance and to play back the content, receiving a broadcast.

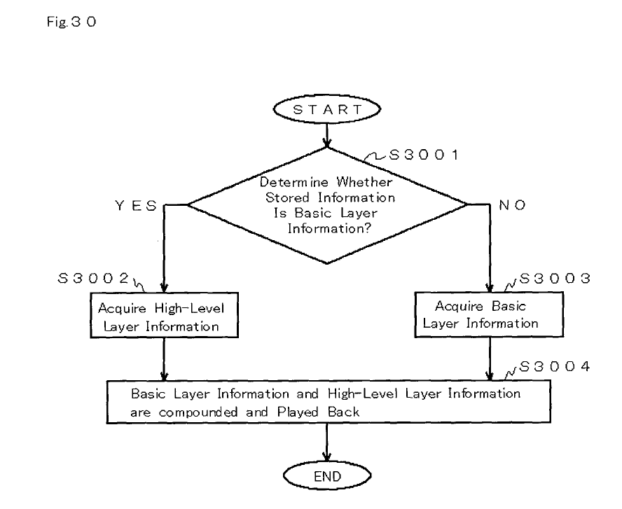

FIG. 30 demonstrates the process in the twenty-fourth embodiment. The means for playback of the content in the twenty-fourth embodiment comprises the following steps:

The layer information stored is judged to determine whether it is the basic layer information or the high-level layer information. (step S3001)

In the case that it is determined to be the basic layer information, the high-level layer information is acquired. (step S3002)

In the case that it is determined to be the high-level layer information, the basic layer information is acquired. (step S3003)

The basic layer information and the high-level layer information are composed and played back. (step S3004)

The twenty-fifth embodiment is the content playback apparatus which synchronizes the basic layer information and the high-level layer information by time stamp.

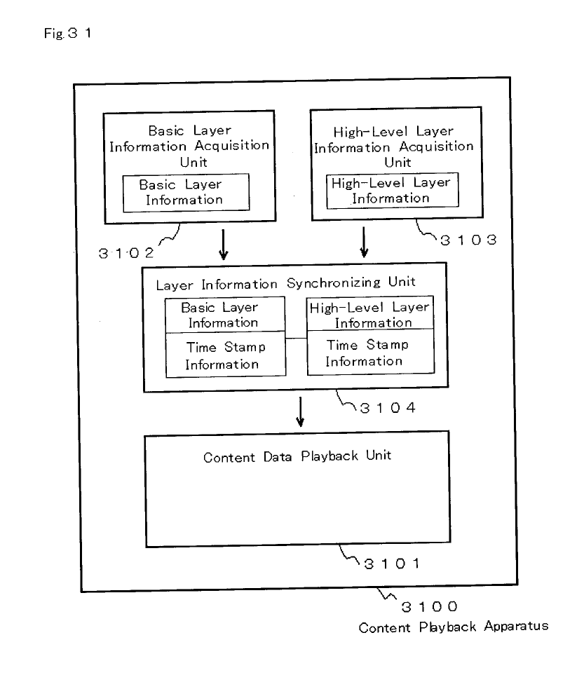

An example of the block diagram of the content playback apparatus in the twenty-fifth embodiment is shown in FIG. 31.

The content playback apparatus in the present embodiment, shown in FIG. 31, comprises the content data playback unit (3101), the basic layer information acquisition unit (3102), the high-level layer information acquisition unit (3103), and the layer synchronizing unit (3104). The content data playback unit (3101), the basic layer information acquisition unit (3102), and the high-level layer information acquisition unit (3103) were already described in the first embodiment.

The layer synchronizing unit (3104) synchronizes layers based on the time stamp information recorded in a set unit of frames composed of multiple frames.

The term “frame” corresponds to the picture comprising an animation or a still picture. Image data is a set unit of frames which continues chronologically.

The term “time stamp information” corresponds to the time data given to the streaming file which is a set unit of frames arranged in an order of time.

Here, the streaming file is generated based on the each layer of information. Each layer of information corresponds to the streaming files generated. However, since the basic layer information differs in the amount of information from the high-level layer information, if the streaming files correlated with each layer information are played back in a state as it is, a difference will arise in a transmission time, thereby causing a gap in a picture.

Hence, it is necessary to make a correspondence of each layer information with the streaming files. In detail, the correspondence becomes possible by attaching the data counted from head to last in playback to the streaming files every frame of a fixed interval. It becomes able to synchronize information between each layer by comparing the original animation stream with the time stamp information of the basic layer information and the high-level layer information in playback time.

The twenty-sixth embodiment is the content playback apparatus described in the twenty-fifth embodiment characterized by that the basic layer information synchronized with the high-level layer information by GOP (Group of Unit) unit or by frame unit.

An example of the block diagram of the content playback apparatus in the twenty-sixth embodiment is shown in FIG. 31.

The content playback apparatus in the present embodiment shown in FIG. 31 (3100) comprises the content data playback unit (3101), the basic layer information acquisition unit (3102), the high-level layer information acquisition unit (3103), and the layer synchronizing unit (3104). The content data playback unit (3101), the basic layer information acquisition unit (3102), and the high-level layer information acquisition unit (3103) were already described in the first embodiment.

The layer synchronizing unit (3104) processes for synchronizing layers at the time of playback based on the GOP (Group of Pictures) unit of the basic layer information acquired in said basic layer information acquisition unit or the time stamp information recorded per frame, and the GOP (Group of Pictures) unit of the high-level layer information acquired in said high-level layer information acquisition unit or the time stamp information recorded per frame.

The term “GOP (Group of Pictures)” corresponds to the group data composed of multiple pictures which is the unit of random access in the animation streaming file of MPEG.

GOP is composed of multiple frames. In MPEG 2, compression in a frame and compression between frames are compounded, thereby an animation is compressed efficiently. Here, the compression in a frame is the compression using spatial functionality in which the adjoining pixel does not change so much (the same brightness continues). The frame in using this compression in a frame is called I frame. The compression between frames, on one hand, is the compression using the functionality between frames in which the adjoining frame does not change so much (the same thing is reflected). It says that the type using functionality with one front frame (the past frame) is the P frame, and says that the type using functionality with one frame of order (the past and the future frame) is the B frame. It is possible to compress efficiently by omitting the same part of the future frame or the past frame thereby data-processing only the different parts. The term GOP corresponds to the sequence of the one continuation which typically includes the one frame of one or more sheets independently realized as a still picture and the P frames or the B frames which refer to it. The animation streaming file of MPEG is the repetition of data which attached the sequence header for synchronization to this GOP. P frames and B frames compressed in this way does not become the picture of one sheet separately, but one frame of order is surely needed.

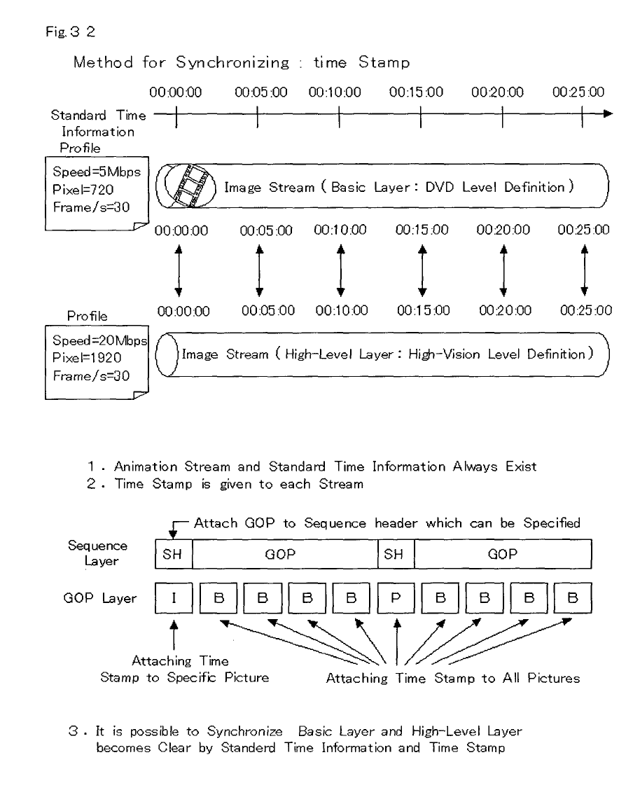

FIG. 32 illustrates the means for synchronizing the basic layer information with the high-level layer information. There are the movie streaming file of the basic layer information and the movie streaming file of the high-level layer information. Here, the time stamp information showing the 5th minute is recorded on the position where each layer of information corresponds to every 5 minutes of playback time of the original animation streaming file. It becomes possible to play back with accurate synchronization by compounding them while checking this correspondence. In the case the layer information is, for example, broadcast from 8:30 p.m. on April 1, the time stamps are recorded to the layer information stored to be compounded with the layer information broadcast, or to the layer information transmitted through the communication network every 5 minutes since 8:30 p.m. on April 1.

In addition, time stamp information may be recorded by absolute time. In the case of absolute time, it is beneficial that the start time of the broadcast is pre-arranged.

Moreover, as for the unit given by the time stamp information, there is the case that it is recorded by a GOP unit and the case that it is recorded by a frame unit. In the case that it is recorded by a GOP unit, it is supposed that it is recorded to the sequence header. Besides in the case that it is recorded by frame unit, the time stamp information may be recorded to all of said I frames, B frames, and P frames, or to one specific frame.

In the case that the time stamp is recorded to one specific frame, the I frame is suitable to be recorded. The I frame is the frame using spatial functionality in which the adjoining pixel changes little. (the same brightness continues), on one hand, P frame is the frame using functionality with one front frame (the past frame) and B frame is the frame using functionality with one frame of order (the past and the future frame). Hence, P frames and B frames are dependent on the I frame. On the other hand, the I frame is suitable to be attached with the time stamp information since it is repeated every specific interval.

The twenty-seventh embodiment is the content playback apparatus which synchronizes the basic layer information and the high-level layer information by ID.

An example of the block diagram of the content playback apparatus in the twenty-seventh embodiment was already shown in FIG. 31.

The content playback apparatus in the present embodiment, shown in FIG. 31, (3100) comprises the content data playback unit (3101), the basic layer information acquisition unit (3102), and the high-level layer information acquisition unit (3103), and the layer information synchronizing unit (3104). The content data playback unit (3101), the basic layer information acquisition unit (3102), and the high-level layer information acquisition unit (3103) were already described in the first embodiment.

The layer information synchronizing unit (3104) performs the processes for synchronizing layer information at the time of playback based on the ID information recorded by the unit of frames comprised of multiple frames.

The ID information is the information assigned to the code which can identify every corresponding element. The difference from the twenty-sixth embodiment is that it is not necessary to correspond to the original animation streaming file with streaming files according to each streaming file. It is possible to play back with synchronization if streaming files correspond to each other by layer information.

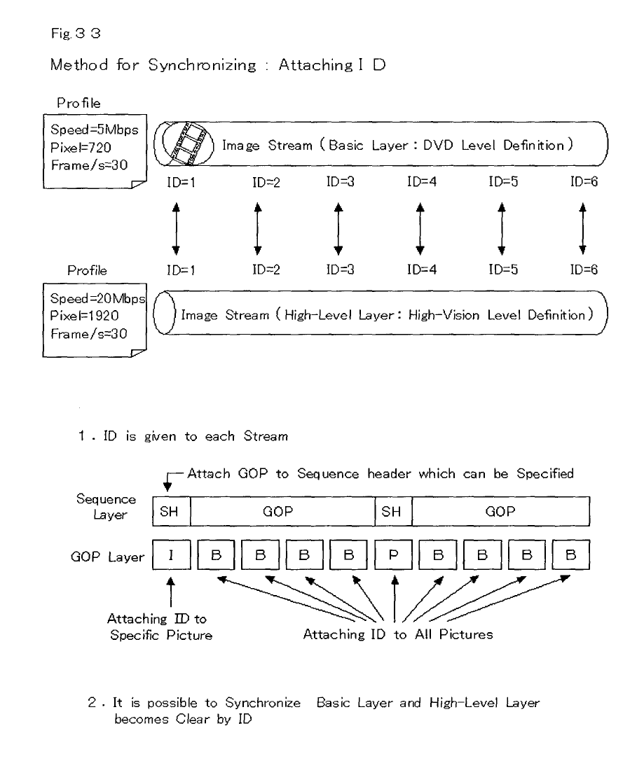

FIG. 33 shows the means for synchronizing the basic layer information with the high-level layer information. There are the movie streaming file of the basic layer information and the movie streaming file of the high-level layer information. Here, the ID information is assigned to synchronize each layer of information. It becomes possible to play back with accurate synchronization by compounding them while checking correspondence of each layer information. The ID may be assigned to the same code, and different codes are assigned and their correspondence is checked according to the correspondence table hereinafter. By the latter way, security is strengthened.

It becomes possible to play back with synchronization by correspondence of the basic layer information with the high-level layer information.

The twenty-eighth embodiment is the cache server which compounds the content data layered by scalability and transmits to the content playback terminal.

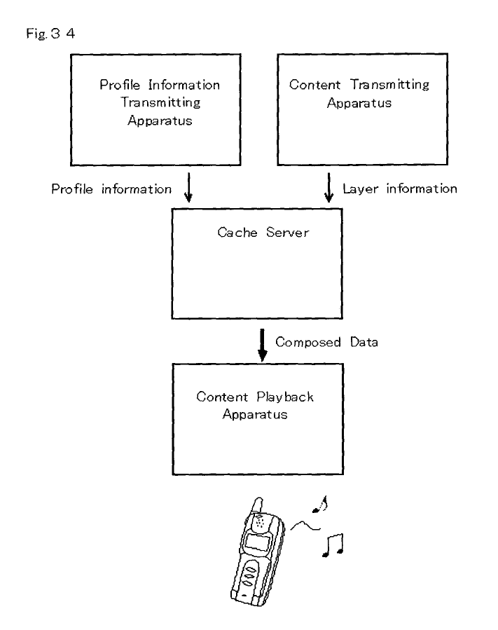

FIG. 34 shows an example of the concept of the present embodiment. As shown in FIG. 34, the cache server in the present embodiment plays the role of mediating between the profile information transmitting apparatus and the content transmitting apparatus. It prepares for the case that the content playback apparatus does not have a function of the recomposing data (for example, the content playback apparatus is a mobile phone etc.). The playback data is generated in the cache server based on the profile information and the layer information transmitted, and is transmitted to the content playback apparatus. Here, it is assumed that the rapid transmission is possible even though the generated playback data has a large capacity, since transmission bandwidth between cache server and the content playback apparatus is wide enough.

Moreover, it is possible to connect the transmitting apparatus with the cache server through the normal internet (the transmission speed is low), and to connect the cache server with the content playback apparatus through the High-throughput telecom network such as ADSL, FTTH. Thereby it becomes possible to transmit at high speeds between the cache server and the content playback apparatus.

An example of the block diagram of the cache server in the twenty-eighth embodiment is shown in FIG. 34.

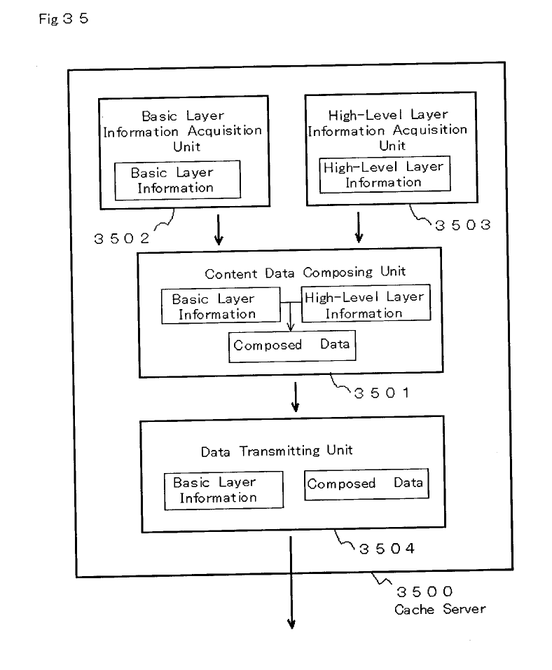

The cache server in the present embodiment shown in FIG. 35 (3500) comprises the content data playback unit (3501), the basic layer information acquisition unit (3502), the high-level layer information acquisition unit (3503), and the data transmitting unit (3504).

The basic layer information acquisition unit (3502) acquires the basic layer information.

The high-level layer information acquisition unit (3503) acquires the high-level layer information.

The term “acquisition” corresponds to the case that the layer information is acquired from outside (for example, the content playback apparatus etc.) and to the case that the layer information is generated inside. Each layer of information acquired is transmitted to the content data composing unit (3501).

The content data composing unit (3501) composes the basic layer information and the high-level layer information. The composed data is the data which includes the high-level layer information and can play back the high-definition content. The composed data is transmitted to the data transmitting unit (3504).

The data transmitting unit (3504) transmits the basic layer information which is necessary to play back the content or the composed data composed in said content data composing unit. Here, it will be possible to play back the content if there is the high-level layer information. Hence, one of the basic layer information and the composed data is suitably transmitted to the content playback apparatus in view of the ability of the content playback apparatus which receives data.

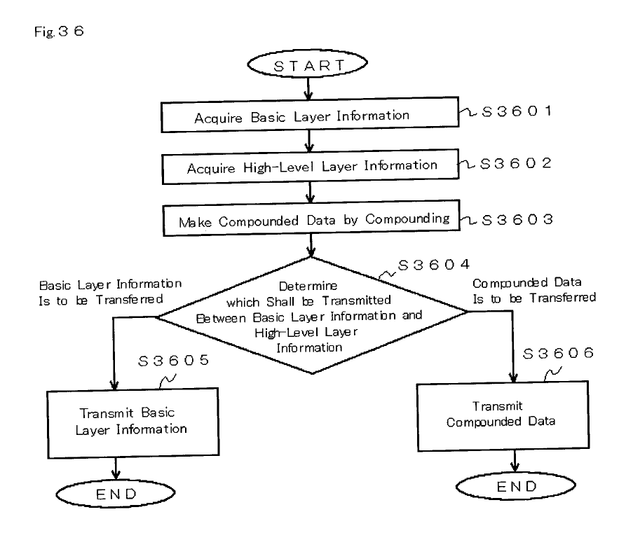

FIG. 36 demonstrates the process in the twenty-eighth embodiment. The means for composing the content in the cache server in the twenty-eighth embodiment comprises the following steps;

The basic layer information is acquired. (the basic layer information acquisition step S3601) The high-level layer information is acquired. (the high-level layer information acquisition unit S3602) step S3601 and step S3602 may be reversed in order.

The basic layer information and the high-level layer information are composed (the content data composing step S3603).

One of the basic layer information and the composed data is determined to be transmitted according to it's destination. (the determining step S3604)

The basic layer information is transmitted in the case that, in the determining step, the data which is necessary to play back the content is determined to be transmitted. (step S3605)

The composed data is transmitted in the case that, in the determining step (step S3604), the data composed in the content data composing step (step S3603) is determined to be transmitted. (step S3606)

The twenty-ninth embodiment is the cache server described in the twenty-eighth embodiment characterized by having the high-level layer information acquisition unit which stores the high-level layer information.

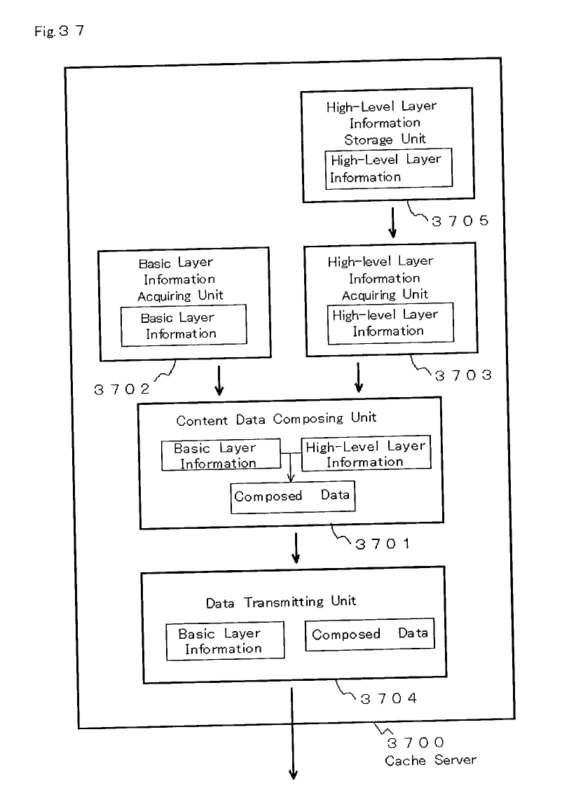

An example of the block diagram of the cache server in the twenty-ninth embodiment is shown in FIG. 37.

The cache server in the present embodiment shown in FIG. 37 (3700) comprises the content data composing unit (3701), the basic layer information acquisition unit (3702), the high-level layer information acquisition unit (3703), the data transmitting unit (3704), and the high-level layer information storage unit (3705). The content data composing unit (3701), the basic layer information acquisition unit (3702), and the data transmitting unit (3704) are the same as described in the twenty-eighth embodiment.

The high-level layer information storage unit (3705) stores the high-level layer information. In the present embodiment, many types of the high-level layer information are stored in advance, thereby it is possible to immediately respond to the needs of users.

The high-level layer information acquisition unit (3703) acquires the high-level layer information from said high-level layer information storage unit. Here, the high-level layer information corresponding to the definition level users' desires (for example, Hi-Vision level) may be acquired.

The thirtieth embodiment is the cache server described in the twenty-eighth embodiment characterized by having the fee collection processing unit which performs the processes for collecting fee.

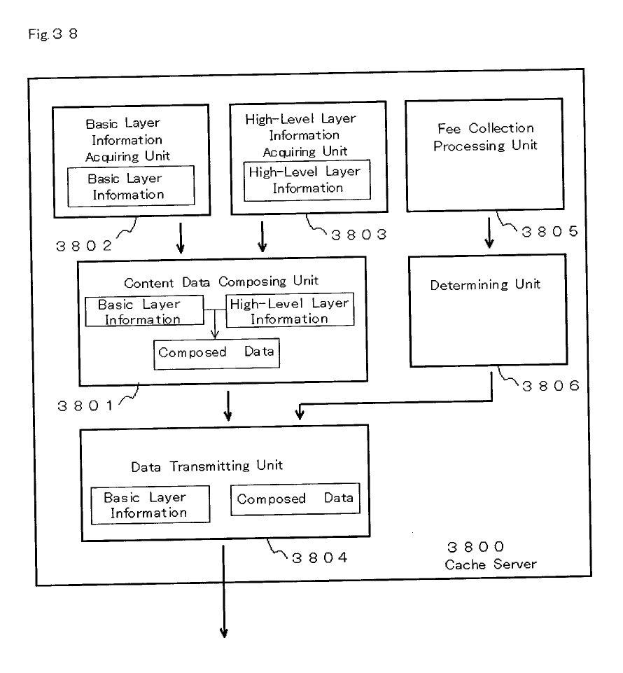

An example of the block diagram of the cache server in the thirtieth embodiment is shown in FIG. 38.

The cache server in the present embodiment shown in FIG. 38 (3800) comprises the content data playback unit (3801), the basic layer information acquisition unit (3802), the high-level layer information acquisition unit (3803), the data transmitting unit (3804), the fee collection processing unit (3805), and the determining unit (3806). The content data composing unit (3801), the basic layer information acquisition unit (3802), and the high-level layer information acquisition unit (3803) are the same as described in the twenty-eighth embodiment.

The fee collection processing unit (3805) discerns the playback terminal and performs the processes for collecting fee.

The content playback apparatus becomes possible to playback the content by using the information acquired from the content transmitting apparatus etc. Hence, the manager of the content playback apparatus can impose the charge which is appropriate to the information transmitted to the user of the content playback apparatus. Here, the cache server may process for the fee collection to the user of the content playback apparatus concerned according to the request of the content transmitting apparatus etc., since it plays a role to mediate both of them.

The cache server may receive the basic layer information from the content playback apparatus with the proviso of the fee collection process. Besides, the composed data generated from the basic layer information received may be transmitted to the content playback apparatus with the proviso of the fee collection process.

At this point, since the process of the fee collection process differs for every content playback apparatus (amount, means etc.), it is important to discern the content playback apparatus. The means for discerning corresponds to attaching a discernment code of the content playback apparatus to the layer information.

The determining unit (3806) determines whether the fee collection process for the playback terminal to which the data is transmitted has been performed.

The reason why it is determined is that the composed data is transmitted to the content playback apparatus with a proviso of the fee collection. In the case, it is determined that the fee collection process has not been performed, the process hereinafter may not be performed.

In the case, it is determined in said determining unit that the fee collection process was performed, the data transmitting unit (3804) transmits the data.

In the case, it is determined that the fee collection process was performed, the composed data etc. is able to be transmitted in view of permission from the determining unit (3806).

It becomes possible to play back the content by mediation of the cache server, even if the content playback apparatus does not have the recomposing function of the streaming file (for example, mobile phone etc.).

Moreover, in the case that multiple cache servers are arranged, in view of Copyright concerns, it is not desirable to put the copy of the work of the movie itself. In that case, the high-level layer information which cannot play back the data by itself may be set and the basic layer information may be acquired according to the request. Since the high-level layer information itself is not the completed work, it may be allowed to be placed on the cache servers, depending upon the various copyright and other laws in effect.

In addition, it is made into the normal Internet network (low speed) between the transmitting apparatus and a cache server, and is made into high-throughput telecom networks, such as ADSL and FTTH, between a cache server and a terminal, and content is placed on the cache server, thereby it is beneficial that a terminal can acquire content at high speeds, if it takes a copy to a cache server, without taking the original to the transmitting apparatus in which the original is placed.

### The Advantages of the Invention

In summary, users download the whole content and store it, thereby making it possible to select the part of the content which corresponds to the user's taste. Here, it becomes possible to play back the content by purchasing the profile information that specifies the part of the content which can be played back. Thereby it is beneficial for the user to avoid the trouble of having to download the content which is desired to be purchased after listening and viewing the sample version.

In addition, the content data is layered by scalability and coded, and the basic layer information which is necessary to play back the content and the high-level layer information for high-definition are acquired according to the situation. Thereby the best means for playback can be taken. It is beneficial that layering the content data by scalability eliminates the instability of a transmission path.

Besides, even in the case that the cache server can mediate and the content playback apparatus does not have a function of recomposing streaming file data (for example, mobile phone etc.), it becomes possible to play back the content.

What is claimed is:

1. A profile information transmitting apparatus comprising;
a profile information acquisition unit which acquires the profile information including the necessary information to make it possible to play back the content which can be composed of the combination of more than one streaming file according to the combination of streaming files;
a content discernment information acquisition unit that acquires the information discerning said content;
a profile information transmitting unit which correlates the profile information acquired in said profile information acquisition unit with the content discernment information acquired in said content discernment information acquisition unit, and transmits them.

2. A content transmitting apparatus comprising;
a content discernment information acquisition unit which acquires the content discernment information discerning said content;
a streaming file data coding unit that codes streaming files of the content which can be composed of the combination of multiple streaming file;
a coded streaming file data transmitting unit which correlates the coded streaming file data coded in the streaming file data coding unit with the content discernment information acquired in said content discernment information acquisition unit, and transmits them.

3. A content playback apparatus comprising;
a coded streaming file data storage unit which stores the coded streaming file data;
a profile information receiving unit which receives the profile information;
a content playback processing unit that recomposes the coded streaming file data stored in the coded streaming file data storage unit based on the profile information received in the profile information receiving unit, and processes for playback of the content.

4. A method for playback of content comprising the step of:
a coded streaming file data storage step wherein a coded streaming file data is stored;
a profile information receiving step wherein profile information is received after said coded stream file data storage step;
a content playback processing step wherein the coded streaming file data stored in the coded streaming file data storage step based on the profile information received in the profile information receiving step is recomposed, and processed for playback of content.

5. A method for playback of content comprising the steps of:
a profile information receiving step wherein the profile information is received;
a coded streaming file data storage step wherein a coded streaming file data is stored after said profile information receiving step;
a content playback processing step wherein the coded streaming file data stored in the coded streaming file data storage step based on the profile information received in the profile information receiving step is recomposed, and processed for playback of the content.

6. The profile information transmitting apparatus of claim 1, further comprising a profile information request receiving unit for receiving the profile information request which is a request for transmitting the profile information.

7. The content playback apparatus of claim 3, further comprising profile information request transmitting unit for transmitting the profile information request.

8. The content playback apparatus of claim 7, further comprising profile information request transmitting unit for transmitting the profile information request with the proviso of fee collection process.

9. The profile information transmitting apparatus of claim 1, wherein said profile information comprises information on playback of the content according to at least any one of the sound streaming files or the image streaming files.

10. The content playback apparatus of claim 3, further comprising a key acquisition unit for acquiring the key to decrypt the profile information according to said profile information encrypted by the key.

11. The content playback apparatus as defined in claim 3, having the key acquisition unit for acquiring the key to decrypt the profile information with the proviso of the fee collection process according to said profile information encrypted by the key.

12. The content playback apparatus as defined in claim 10, having the key request information transmitting unit to transmit the key request information for requiring the key.

13. The content playback apparatus of claim 10, further including a key request information transmitting unit for transmitting the key request information which requests the key with the proviso of the fee collection process.

14. The content playback apparatus of claim 3, wherein said coded streaming file data stored in said streaming file data storage unit comprises multiple streaming file data distributed and allocated; and
said playback processing unit recomposes only necessary streaming file data from said coded streaming file data based on said profile information.

15. A content playback apparatus comprising;
a content data playback unit, a playback unit playing back the content data layered by scalability, which plays back the basic layer information, necessary for playback of the content or the basic layer information and the high-level layer information used for playback of the content at high scalability;
a basic layer information acquisition unit which acquires said basic layer information;
a high-level layer information acquisition unit which acquires said high-level layer information.

16. The content playback apparatus of claim 15, wherein said scalability is of time or/and space or/and SNR (Signal to Noise Ratio).

17. The content playback apparatus of claim 15, wherein the basic layer information acquired in said basic layer information acquisition unit is the content data used for preview of the content.

18. The content playback apparatus of claim 17, having the fee collection processing unit for high-level layer information which makes it possible to play back the content with the proviso of the fee collection process by using the high-level layer information acquired in said high-level layer information acquisition unit.

19. The content playback apparatus of claim 17, having the fee collection processing unit for basic layer information which makes it possible to play back the content with the proviso of the fee collection process by using the basic layer information acquired in said basic layer information acquisition unit.

20. The content playback apparatus of claim 15, wherein said basic layer information acquisition unit acquires the basic layer information broadcast.

21. The content playback apparatus of claim 20, wherein said high-level layer information acquisition unit acquires the high-level layer information through the communication network.

22. The content playback apparatus of claim 15, wherein said basic layer information acquisition unit acquires the basic layer information through the communication network.

23. The content playback apparatus of claim 22, wherein said high-level layer information acquisition unit acquires the high-level layer information broadcast.

24. A content playback apparatus comprising;
a layer information storage unit storing said basic layer information or high-level layer information;
other layer information processing unit effecting the process for acquiring the high-level layer information or the basic layer information which are the information on a different layer from the information stored in said layer information storage unit.

25. A content playback apparatus comprising;
a content data playback unit, a playback unit of content data layered by scalability, playing back the basic layer information necessary for playback of the content and the high-level layer information used for playback of the content at high scalability;
a basic layer information acquisition unit acquiring said basic layer information;
a high-level layer information acquisition unit acquiring said high-level layer information;
a layer synchronizing unit synchronizing layers at the point of time of playback based on the time stamp information recorded in a set unit of frames composed of multiple frames.

26. The content playback apparatus of claim 25, wherein said layer synchronizing unit synchronizes layers at the point of time of playback based on a GOP (Group of Pictures) unit of the basic layer information acquired in said basic layer information acquisition unit or the time stamp information recorded in a frame unit, and a GOP (Group of Pictures) unit of the high-level layer information acquired in said high-level layer information acquisition unit or the time stamp information recorded in a frame unit.

27. A content playback apparatus comprising;
a content data playback unit, the playback unit of the content data layered by scalability, playing back basic layer information necessary for playback of the content and the high-level layer information used for playback of the content at high scalability;
a basic layer information acquisition unit, acquiring said basic layer information;
a high-level layer information acquisition unit, acquiring said high-level layer information;
a layer synchronizing unit, synchronizing layers at the time of playback based on the ID information recorded in a set unit of frames composed of multiple frames.

28. A cache server which composes content data layered by scalability and transmits to a terminal, comprising;
a basic layer information acquiring the basic layer information;
a high-level layer information acquiring high-level layer information;
a content data compounding unit compounding the basic layer information with the high-level layer information;
a data transmitting unit, transmitting the basic layer information necessary for playback of the content or the compounded data compounded in said data compounding unit.

29. The cache server of claim 28, comprising;
a high-level layer information storage unit storing the high-level layer information;
a high-level layer information acquisition unit, acquiring the high-level layer information from said high-level layer information storage unit.

30. The cache server of claim 28, comprising;
a fee collection processing unit for the fee collection process discerning the terminal;
a determining unit for determining whether the fee collection process is performed for the terminal to which the data is transmitted;
said data transmitting unit, transmitting the data if the fee collection process is determined to be performed by said determining unit.
